(19) United States
(12) Patent Application Publication
(10) Pub. No.: US 2014/0098992 A1
(43) Pub. Date: Apr. 10, 2014

(54) Electronic divice, selection method, acquisition method, electronic appratus, synthesis method and synthesis program

(71) Applicant: NIKON CORPORATION, Tokyo (JP)

(72) Inventors: Takeshi YAGI, Tokyo (JP); Mikiya Tanaka, Chigasaki (JP); Tomomi Takashina, Yokohama (JP); Yuji Moto, Yokohama (JP)

(73) Assignee: NIKON CORPORATION, Tokyo (JP)

(21) Appl. No.: 14/029,421

(22) Filed: Sep. 17, 2013

Related U.S. Application Data
(63) Continuation of application No. PCT/JP2012/057134, filed on Mar. 21, 2012.

(30) Foreign Application Priority Data
Mar. 25, 2011 (JP) 2011-067757
Apr. 5, 2011 (JP) 2011-083595
Apr. 13, 2011 (JP) 2011-089063
Apr. 22, 2011 (JP) 2011-095986

(51) Int. Cl. G06T 7/20

(52) U.S. Cl. CPC G06T 7/20
USPC 382/103

(57) ABSTRACT

An electronic device (1) includes an imaging unit (10), and an extraction unit (20) that is configured to extracts rhythm information indicating a pattern of a spatial change in an image captured by the imaging unit (10). The extraction unit (20) includes a first storage unit (22), a calculation unit (24), and a selection unit (26), the first storage unit being storing rhythm information associated with a pattern of a spatial change in a unit region in an image, the calculation unit being calculating a pattern of a spatial change in a unit region in the image captured by the imaging unit (10), the selection unit being selecting the rhythm information corresponding to the pattern of the spatial change in the unit region calculated by the calculation unit (24), from the first storage unit (22).

Priority is claimed on Japanese Patent Application No. 2011-067757, filed on Mar. 25, 2011, Japanese Patent Application No. 2011-083595, filed on Apr. 5, 2011, Japanese Patent Application No. 2011-089063, filed on Apr. 13, 2011, and Japanese Patent Application No. 2011-095986, filed on Apr. 22, 2011. This is a Continuation Application of International Application No. PCT/JP2012/057134, filed Mar. 21, 2012. The contents of the aforementioned applications are incorporated herein by reference.

### BACKGROUND

### Technical Field

The present invention relates to an electronic device, a selection method, an acquisition method, an electronic apparatus, a synthesis method, and a synthesis program.

In the related art, a technology that extracts a predetermined object (for example, the face of a person) by pattern-matching from a moving picture is disclosed (for example, refer to Japanese Unexamined Patent Application, First Publication No. 2009-31469). According to Japanese Unexamined Patent Application, First Publication No. 2009-31469, an image region of a predetermined object can be displayed on a display screen.

In the related art, a method that extracts rhythm of music is known. For example, in Japanese Unexamined Patent Application, First Publication No. 2006-192276, a video game apparatus is disclosed which includes sensor means attached to a human body for detecting motion of the attached location, tempo extraction means for extracting detection tempo of a detection value detected by the sensor means, music output means for outputting music, rhythm extraction means for extracting rhythm of the music, and evaluation means for evaluating whether or not the detection tempo extracted by the tempo extraction means synchronizes with the rhythm of the music extracted by the rhythm extraction means.

### SUMMARY

In the technology disclosed in Japanese Unexamined Patent Application, First Publication No. 2009-31469, since a captured image itself or an object itself is not digitized (indexed), there is a problem that captured images or objects cannot be compared to each other. In addition, since captured images or objects cannot be compared to each other, there is a problem that various application processes which apply comparison results between the captured images or between the objects (for example, grouping of the captured image or the object based on similarity of the captured image or the object, grouping of the imaging device based on the similarity of the captured image or the object by each imaging device, extraction of the captured image or the object similar to the reference captured image or the reference object, and extraction of similar points from different images) cannot be realized.

Moreover, in the related art, in the electronic apparatus in the technology disclosed in Japanese Unexamined Patent Application, First Publication No. 2006-192276, the tempo can be extracted from a signal detected from the sensor which detects the motion, such as an acceleration sensor or the like included in the electronic apparatus, and the information that indicates the tempo can be displayed on the display apparatus. However, since the tempo reflects only the information such as the motion of an operator, there is a problem that variation of expression is few.

An aspect according to the present invention provides an electronic device that can easily compare the captured images or the objects and easily obtains numerical values (indexes) indicating the captured image itself or the object itself.

An object of another aspect of the present invention provides a technology that can express detected information in more expressive way.

According to an aspect of the present invention, an electronic device includes a storage unit that is configured to store rhythm information which indicates a pattern of a spatial change in an image associated with a pattern of a spatial change in a unit region in an image; an imaging unit; a calculation unit that is configured to calculate a pattern of a change in a unit region in an image captured by the imaging unit; and a selection unit that is configured to select the rhythm information from the storage unit, the rhythm information being corresponding to the pattern of the change in the unit region calculated by the calculation unit.

In the above mentioned electronic device, the storage unit may store the rhythm information associated with a combination of a first pattern and a second pattern, the first pattern being a pattern of a change in a unit region and the second pattern being a pattern of a change in a unit region, wherein the calculation unit may calculate a pattern of a change in a unit region which configures a main object in the captured image, and a pattern of a change in a unit region which configures a portion other than the main object, and wherein the selection unit may select the rhythm information, in which the first pattern corresponds to a pattern of a change in a unit region which configures the main object calculated by the calculation unit and the second pattern corresponds to a pattern of a change in a unit region which configures the portion other than the main object calculated by the calculation unit, from the storage unit.

In the above mentioned electronic device, the unit region may be a pixel group configured of adjacent pixels having a predetermined number, and a pattern of a change in a unit region may be information that indicates a spatial change in an average pixel value, a maximum pixel value, a minimum pixel value, or a medium value of a pixel value for the each pixel group.

In the above mentioned electronic device, the unit region may be a pixel group configured of adjacent pixels having a predetermined number, and a pattern of a change in a unit region may be information in which changes in a frequency region and a time region are extracted as rhythm from information of each pixel within the pixel group.

In the above mentioned electronic device, the unit region may be a pixel group configured of adjacent pixels in which a difference of pixel values is a predetermined value or less, and a pattern of a change in a unit region may be information that indicates a spatial change of an average pixel value, a maximum pixel value, a minimum pixel value, or a medium value of a pixel value for each pixel group.

In the above mentioned electronic device, a pattern of a change in a unit region may be information that indicates a distribution of a pixel group configured of adjacent pixels in which a difference of pixel values is a predetermined value or less.

According to another aspect of the present invention, a selection method that selects rhythm information of an image captured by an imaging unit, in an electronic device including a storage unit that is configured to store the rhythm information that indicates a pattern of a spatial change in an image associated with a pattern of a spatial change in a unit region in the image, includes: calculating a pattern of a change in a unit region in the captured image by using a calculation unit of the electronic device, and selecting the rhythm information from the storage unit by using a selection unit of the electronic device, the rhythm information being corresponding to the pattern of the change in the unit region calculated by the calculation unit.

According to still another aspect, an electronic device includes: an imaging unit; an extraction unit that is configured to extract an object graphic which is a graphic indicating a region of object from a moving picture captured by the imaging unit; and an acquisition unit which acquires a variation of an area of the object graphic of an object or a period of a change in the area of the object graphic of the object as rhythm information indicating a temporal change of the object, the first object being extracted by the extraction unit.

In the above mentioned electronic device, the extraction unit may extract a circumscribing rectangle, which circumscribes an object, as the object graphic.

In the above mentioned electronic device, the acquisition unit may acquire a variation of an aspect ratio of the circumscribing rectangle or a period of a change in the aspect ratio of the circumscribing rectangle as the rhythm information, instead of or in addition to a variation of an area of the circumscribing rectangle or a period of a change in the area of the circumscribing rectangle, the circumscribing rectangle being extracted as the object graphic.

According to still another aspect of the present invention, an electronic device includes: an imaging unit; an extraction unit that is configured to extract a circumscribing rectangle, which circumscribes an object, as an object graphic from a moving picture captured by the imaging unit, the object graphic being a graphic indicating a region of an object; and an acquisition unit that is configured to acquire a variation of a length of a long side or a short side of the circumscribing rectangle or a period of a change in the length of the circumscribing rectangle as rhythm information indicating a temporal change in the object, the circumscribing rectangle being extracted as the object graphic of an object by the extraction unit.

In the electronic device, the acquisition unit may acquire a variation of an aspect ratio of the circumscribing rectangle or a period of a change in the aspect ratio of the circumscribing rectangle as the rhythm information, instead of or in addition to a variation of the length of the long side or the short side, or a period of a change of the length of the circumscribing rectangle.

According to still another aspect of the present invention, an acquisition method of rhythm information in an electronic device which acquires the rhythm information from a moving picture, the rhythm information being indicating a temporal change in an object in a moving picture, includes: extracting an object graphic from the moving picture by using an extraction unit of the electronic device, the object graphic being a graphic indicating a region of an object, and acquiring a variation of an area of the object graphic of a first object or a period of the change in the area of the object graphic of the first object as rhythm information by using an acquisition unit of the electronic device, the first object being extracted by the extraction unit and the rhythm information being indicating a temporal change in the object.

According to still another aspect of the present invention, an electronic device includes: an imaging unit; and an extraction unit that is configured to extract rhythm information indicating a pattern of a color change of an object in a moving picture which is captured by the imaging unit.

In the above mentioned electronic device, the device may further include a correction unit that is configured to correct a color of the moving picture to a color obtained in a case the moving picture was captured under a predetermined reference light, wherein the extraction unit extracts the rhythm information from a moving picture which is corrected by the correction unit.

In the above mentioned electronic device, the extraction unit may include: a storage unit that is configured to store the rhythm information associated with a pattern of a color change of a unit region configuring the object; a calculation unit that is configured to calculate the pattern of the color change of the unit region in the moving picture; and a selection unit that is configured to select the rhythm information from the storage unit, the rhythm information being corresponding to the pattern of the color change of the unit region calculated by the calculation unit.

In the above mentioned electronic device, the unit region is a pixel group configured of adjacent pixels having a predetermined number, and the pattern of the color change of the unit region is information that indicates a temporal change of an average pixel value, a maximum pixel value, a minimum pixel value, or a medium value of a pixel value for each pixel group.

In the above mentioned electronic device, the unit region may be a pixel group configured of adjacent pixels in which a difference of pixel values is a predetermined value or less, and the pattern of the color change of the unit region may be information that indicates a temporal change of an average pixel value, a maximum pixel value, a minimum pixel value, or a medium value of a pixel value for each pixel group.

In the electronic device, the unit region may be a pixel group configured of adjacent pixels in which a difference of pixel values is a predetermined value or less, and the pattern of the color change of the unit region may be information indicating a temporal change of a distribution of the pixel group.

In the electronic device, the color change includes changes of any one or two or more of hue, chroma, brightness, chromaticity, and a contrast ratio.

According to still another aspect of the present invention, a selection method that selects rhythm information of a moving picture captured by an imaging unit, in an electronic device comprising a storage unit that is configured to store the rhythm information that indicates a pattern of a color change in an object in the moving picture associated with a pattern of a color change of a unit region configuring the object in the moving picture, includes: calculating the pattern of the color change of the unit region in the moving picture by using a calculation unit of the electronic device, and selecting the rhythm information from the storage unit, the rhythm information being corresponding to the pattern of the color change of the unit region calculated by the calculation unit by using a selection unit of the electronic device.

According to still another aspect of the present invention, an electronic apparatus includes: a plurality of detection units that is configured to detect a plurality of signals from a detection target, the plurality of signals being indicating characteristics of a target; an extraction unit that is configured to extract each of patterns of the signals, which repeatedly appear, from the plurality of signals detected by the plurality of detection units; and a synthesis unit that is configured to synthesize each extracted pattern.

In addition, according to still another aspect of the present invention, a synthesis method includes: a plurality of detection steps that detect a plurality of signals indicating characteristics of a target from a detection target; an extraction step that extracts each of the patterns of the signals, which repeatedly appear, from plurality of signals detected at the plurality of detection steps; and a synthesis steps that synthesizes each extracted pattern.

According to still another aspect of the present invention, a synthesis program causing a computer, which comprises a storage unit in which information indicating a plurality of signals detected by a plurality of detection units is stored, to execute: an extraction step that reads information, which indicates a plurality of signals, from the storage unit, and extracts the each of the patterns of the signals, which repeatedly appear, from the information indicating the plurality of read signals; and a synthesis step of synthesizing each extracted pattern.

According to the aspects of the present invention, numerical values (rhythm information) indicating the captured image itself or the object itself can be simply acquired from the captured image or the object. Moreover, the captured images or the objects can be simply compared to each other using the numerical values. Furthermore, comparison results of the captured images or the objects can be utilized for various application processes (for example, grouping of the captured images or objects based on similarity of the captured images or objects, grouping of the imaging devices based on similarity of the captured images or the objects by each imaging device, extraction of a captured image or an object similar to the reference captured image or the reference object, and extraction of similar points from images different from one another).

Moreover, according to other aspects of the present invention, the detected information can be expressed in expressive way.

### BRIEF DESCRIPTION OF THE DRAWINGS

FIG. 1 is a configuration diagram showing an example of an electronic device according to a first embodiment of the present invention.

FIG. 2A is an explanatory diagram for explaining a process of an extraction unit.

FIG. 2B is an explanatory diagram for explaining the process of the extraction unit.

FIG. 2C is an explanatory diagram for explaining the process of the extraction unit.

FIG. 3 is an explanatory diagram for explaining the process of the extraction unit.

FIG. 4 is a flowchart showing an example of an operation of the electronic device.

FIG. 5A is an explanatory diagram for explaining another process of the extraction unit.

FIG. 5B is an explanatory diagram for explaining another process of the extraction unit.

FIG. 5C is an explanatory diagram for explaining another process of the extraction unit.

FIG. 6 is a schematic diagram showing an example of an electronic device according to a second embodiment of the present invention.

FIG. 7 is an explanatory diagram for explaining process of an extraction unit.

FIG. 8 is an explanatory diagram for explaining the process of the extraction unit.

FIG. 9 is an explanatory diagram for explaining the process of the extraction unit.

FIG. 10A is an explanatory diagram for explaining process of an acquisition unit.

FIG. 10B is an explanatory diagram for explaining the process of the acquisition unit.

FIG. 10C is an explanatory diagram for explaining the process of the acquisition unit.

FIG. 11 is a flowchart showing an example of an operation of the electronic device.

FIG. 12 is a configuration diagram showing an example of an electronic device according to a third embodiment of the present invention.

FIG. 13 is an explanatory diagram for explaining process of an extraction unit.

FIG. 14A is an explanatory diagram for explaining the process of the extraction unit.

FIG. 14B is an explanatory diagram for explaining the process of the extraction unit.

FIG. 15 is an explanatory diagram for explaining the process of the extraction unit.

FIG. 16 is a flowchart showing an example of an operation of the electronic device.

FIG. 17A is an explanatory diagram for explaining another process of the extraction unit.

FIG. 17B is an explanatory diagram for explaining another process of the extraction unit.

FIG. 18A is an explanatory diagram for explaining another process of the extraction unit.

FIG. 18B is an explanatory diagram for explaining another process of the extraction unit.

FIG. 18C is an explanatory diagram for explaining another process of the extraction unit.

FIG. 18D is an explanatory diagram for explaining another process of the extraction unit.

FIG. 19 is a block configuration diagram of an electronic apparatus in a fourth embodiment of the present invention.

FIG. 20 is a diagram for explaining a direction in which the electronic apparatus is swung in the present embodiment.

FIG. 21 is a diagram for explaining a process of a pattern extraction unit.

FIG. 22A is a diagram showing another example of a signal showing a normalized motion which is input to the pattern extraction unit.

FIG. 22B is a diagram showing an autocorrelation function which is calculated by the pattern extraction unit.

FIG. 23 is a diagram for explaining a process of a normalization unit.

FIG. 24 is a diagram for explaining a process of a synthesis unit.

FIG. 25 is a flowchart showing a flow of a process of the electronic apparatus of the fourth embodiment.

FIG. 26A is a configuration example of a communication system in a fifth embodiment.

FIG. 26B is a configuration example of the communication system in the fifth embodiment.

FIG. 27 is a block configuration diagram of an electronic apparatus in a fifth embodiment.

FIG. 28 is a diagram for explaining a process of a data extraction unit.

FIG. 29 is a diagram for explaining a process of a motion video synthesis unit.

FIG. 30 is a diagram showing an example of a table which is stored in an atmosphere data storage unit.

FIG. 31 is a flowchart showing a flow of the process of the electronic apparatus of the fifth embodiment.

### DESCRIPTION OF EMBODIMENTS

### First Embodiment

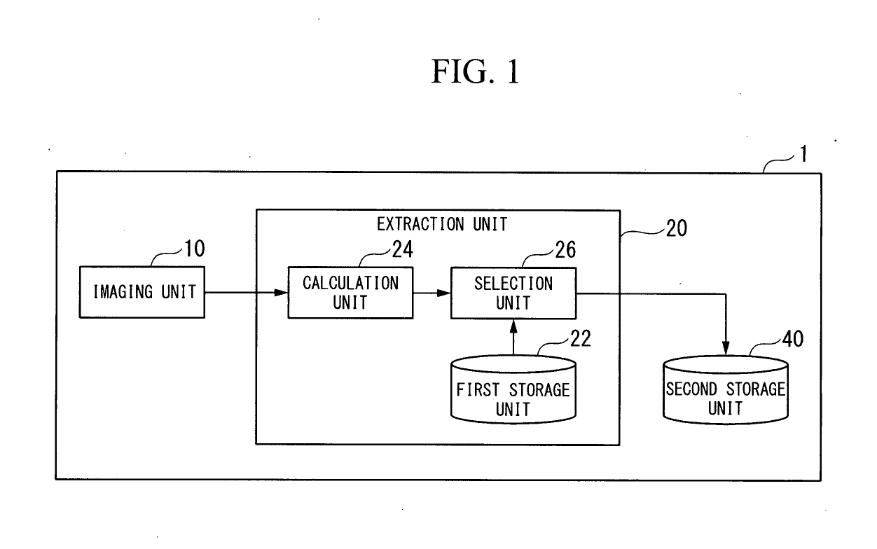

Hereinafter, a first embodiment of the present invention will be described with reference to the drawings. FIG. 1 is a configuration diagram showing an example of an electronic device 1 according to the first embodiment of the present invention.

For example, the electronic device 1 is a digital camera, and as shown in FIG. 1, includes an imaging unit 10, an extraction unit 20, and a second storage unit 40. The extraction unit 20 includes a first storage unit 22, a calculation unit 24, and a selection unit 26.

The imaging unit 10 is a camera which captures a still image and a moving picture. The extraction unit 20 extracts rhythm information that indicates a pattern of a spatial change in a captured image (still image) captured by the imaging unit 10. The second storage unit 40 stores the rhythm information extracted by the extraction unit 20.

The first storage unit 22 stores the above-described rhythm information associated with a pattern of a spatial change in a unit region (hereinafter, referred to as a “pixel group”) in an image. Specifically, the first storage unit 22 stores the rhythm information associated with a combination of a first pattern which is a pattern of a change in the pixel group and a second pattern which is a pattern of a change in the pixel group.

The pixel group is configured of adjacent pixels having a predetermined number. The pattern of the change in the pixel group in the image is information that indicates the spatial change in an average pixel value (average value of pixel values of a plurality of pixels in the pixel group) for each pixel group. The spatial change means a change according to a position in the image.

As described above, the first pattern is the pattern of the change in the pixel group, and mainly indicates the pattern of the change in the pixel group which configures a main object (for example, an object captured in a center region) in the image. On the other hand, the second pattern is the pattern of the change in the pixel group which mainly configures portions other than the main object in the image.

An aspect, which stores the rhythm information associated with the combination of the first pattern and the second pattern, is not particularly limited, and in the present embodiment, the aspect may be an aspect in which the first storage unit 22 stores each of the first pattern and the second pattern, and stores the rhythm information for each combination of identification information (hereinafter, referred to as a “first pattern identification information) identifying the first pattern and identification information (hereinafter, referred to as a “second pattern identification information”) identifying the second pattern. Moreover, the aspect, in which each of the first pattern and the second pattern is stored and the rhythm information is stored for each combination of the first pattern identification information and the second pattern identification information, is advantageous for maintenance of each information piece (first pattern, second pattern, and rhythm information).

Moreover, each information piece stored by the first storage unit 22 may be the information which is prepared by the electronic device 1, the information which is acquired by the electronic device 1 from the outside, or the information which is input by a user of the electronic device 1. Moreover, as an aspect which is prepared by the electronic device 1, the calculation unit 24 calculates the first pattern and the second pattern based on a sample image (may be an image captured by the imaging unit 10 or an image acquired from the outside) to calculate (generate) the first pattern and the second pattern in advance, and the first pattern, the second pattern, and the rhythm information are stored in the first storage unit 22.

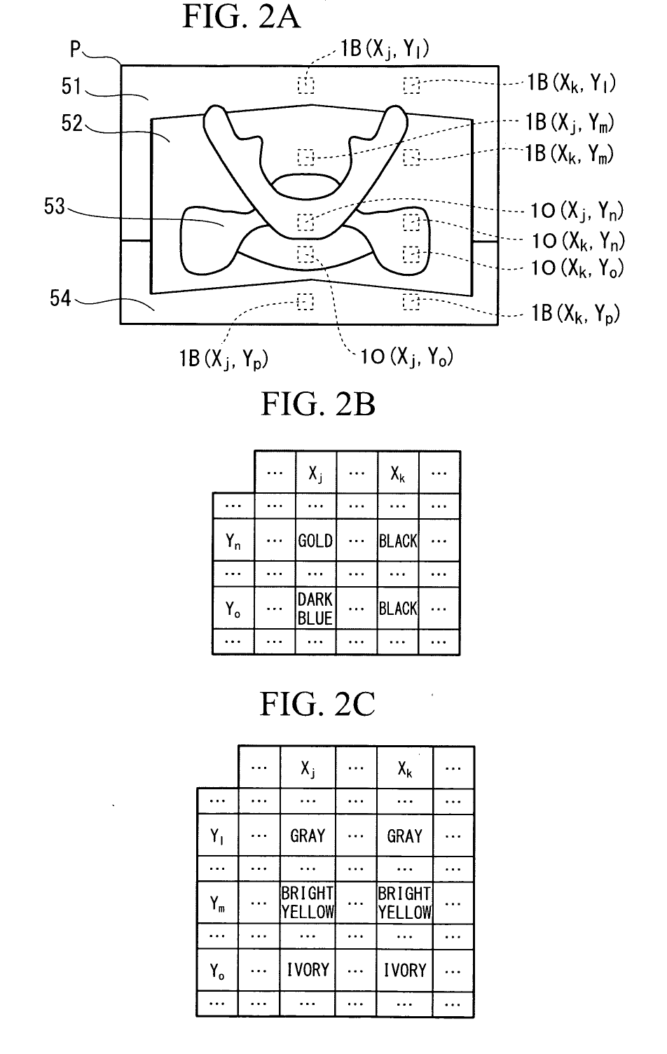

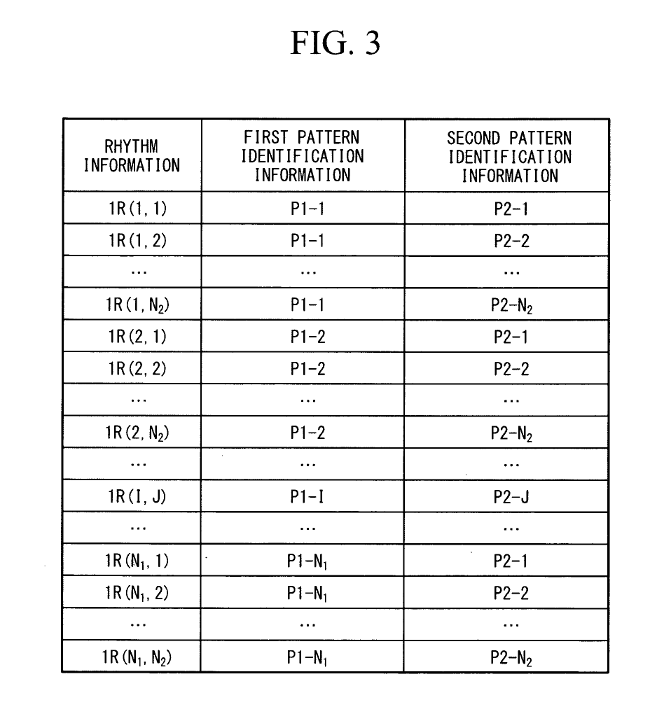

Hereinafter, a process according to the extraction unit 20 will be described in detail with reference to FIGS. 2A, 2B, 2C, and 3. FIGS. 2A, 2B, 2C, and 3 are explanatory diagrams for explaining the process of the extraction unit 20.

An image P shown in FIG. 2A is an example of a sample image for calculating the first pattern and the second pattern. Specifically, the sample image P is an image captured by the imaging unit 10 with a helmet 53, which is placed before a folding screen 52, as a subject.

1O (Xⱼ, Yₙ), 1O (Xⱼ, Yₒ), 1O (Xₖ, Yₙ), and 1O (Xₖ, Yₒ) in FIG. 2A are examples of the pixel group configuring the main object (helmet 53). The average pixel value of the pixel group 1O (Xⱼ, Yₙ) is set to the pixel value representing gold, the average pixel value of the pixel group 1O (Xⱼ, Yₒ) is set to the pixel value representing dark blue, and the average pixel values of the pixel group 1O (Xₖ, Yₙ) and the pixel group 1O (Xₖ, Yₒ) are set to the pixel values representing black.

1B (Xⱼ, Yₗ), 1B (Xⱼ, Yₘ), 1B (Xⱼ, Yₚ), 1B (Xₖ, Yₗ), 1B (Xₖ, Yₘ), and 1B (Xₖ, Yₚ) in FIG. 2A are examples of the pixel group configuring portions other than the main object (helmet 53). The average pixel values of the pixel group 1B (Xⱼ, Yₗ) and the pixel group 1B (Xₖ, Yₗ) are set to the pixel values representing gray, the average pixel values of the pixel group 1B (Xⱼ, Yₘ) and the pixel group 1B (Xₖ, Yₘ) are set to the pixel values representing bright yellow, and the average pixel values of the pixel group 1B (Xⱼ, Yₚ) and the pixel group 1B (Xₖ, Yₚ) are set to the pixel values representing ivory.

FIG. 2B is an example of the first pattern based on FIG. 2A. Specifically, FIG. 2B is the pattern of the change in the pixel group configuring the main object (helmet 53) of the sample image P shown in FIG. 2A. For example, in FIG. 2B, “gold” which is the value defined by Xⱼ and Yₙ indicates an intent that the average pixel value of the pixel group O (Xⱼ, Yₙ) shown in FIG. 2A is gold. That is, the entirety of FIG. 2B indicates a pattern of a change (the change corresponding to the position (X, Y)) in a spatial color of the main object (helmet 53). Furthermore, first pattern identification information which identifies the first pattern shown in FIG. 2B is set to “P1-I”.

FIG. 2C is an example of the second pattern based on FIG. 2A. Specifically, FIG. 2C is the pattern of the change in the pixel group configuring portions (wall surface 51, folding screen 52, and base surface 54) other than the main object (helmet 53) of the sample image P shown in FIG. 2A. For example, in FIG. 2C, the “gray” which is the value defined by Xⱼ and Yₗ indicates an intent that the average pixel value of the pixel group 1B (Xⱼ, Yₗ) shown in FIG. 2A is gray. That is, the entirety of FIG. 2C indicates a pattern of a change (the change corresponding to the position (X, Y)) in a spatial color of portions (wall surface 51, folding screen 52, and base surface 54) other than the main object. Furthermore, second pattern identification information which identifies the second pattern shown in FIG. 2C is set to “P2-J”.

The first storage unit 22 stores the first pattern shown in FIG. 2B and the second pattern shown in FIG. 2C which are calculated from the sample image P shown in FIG. 2A. Moreover, in actuality, the first storage unit 22 stores the plurality of first patterns and the plurality of second patterns which are calculated from the plurality of sample images. For example, the first storage unit 22 stores N₁ (N₁ is N or less) first patterns and N₂ (N₂ is N or less) second patterns (“N₁” which is the number of the first patterns and “N₂” which is the number of the second patterns may not necessarily coincide with each other) which are calculated from N sample images.

FIG. 3 is an example of the rhythm information for each combination of the first pattern identification information and the second pattern identification information. Specifically, the rhythm information shown in FIG. 3 is N₁×N₂ rhythm information (“1R(1,1)” to “1R(N₁,N₂)”) corresponding to the combinations such as N₁×N₂ of N₁ first pattern identification information (“P1-1” to “P1-N₁”) and N₂ second pattern (“P1-1” to “P1-N₂”).

That is, as shown in FIG. 3, the first storage unit 22 stores N₁×N₂ rhythm information for each combination of the first pattern identification information identifying N₁ first patterns and the second pattern identification information identifying N₂ second patterns. For example, in FIG. 3, as one among N₁×N₂ rhythm information, the first storage unit 22 stores the rhythm information “1R(I,J)” which is associated with the first pattern identification information “P1-I” which identifies the first pattern shown in FIG. 2B and the second pattern identification information “P2-J” which identifies the second pattern shown in FIG. 2C.

As described above, as shown in FIGS. 2B, 2C, and 3, the first storage unit 22 stores the rhythm information associated with the combination of the first pattern and the second pattern.

In the first storage unit 22, as shown in FIGS. 2B, 2C, and 3, in the state where the first storage unit 22 stores the rhythm information associated with the combination of the first pattern and the second pattern, the calculation unit 24 extracts the main object from the image captured by the imaging unit 10.

The calculation unit 24 extracting the main object calculates the average pixel value for each pixel group configuring the main object. That is, the calculation unit 24 calculates the pattern of the spatial color change of the pixel groups configuring the main object. Moreover, the calculation unit 24 calculates the average pixel value for each pixel group configuring portions other than the main object. That is, the calculation unit 24 calculates the pattern of the spatial color change of the pixel group configuring portions other than the main object. The calculation unit 24 supplies the calculated pattern of the spatial color change of the pixel group configuring the main object, and the calculated pattern of the spatial color change of the pixel group configuring portions other than the main object to the selection unit 26.

The selection unit 26 acquires the pattern of the spatial color change of the pixel group configuring the main object and the pattern of the spatial color change of the pixel group configuring portions other than the main object, from the calculation unit 24, and the selection unit 26 selects the rhythm information, in which the first pattern corresponds to the pattern of the spatial color change of the pixel group configuring the main object and the second pattern corresponds to the pattern of the spatial color change of the pixel group configuring portions other than the main object, from the first storage unit 22.

For example, the selection unit 26 selects the first pattern which coincides with or is most similar to the pattern of the spatial color change of the pixel group configuring the main object, selects the second pattern, which coincides with or is most similar to the pattern of the spatial color change of the pixel group configuring portions other than the main object, among the second patterns which constitutes a pair with the first pattern, and acquires the rhythm information corresponding to the combination of the selected first pattern and second pattern. The selection unit 26 stores the acquired rhythm information in the second storage unit 40. Moreover, the rhythm information stored in the second storage unit 40 is used for comparison of captured images, or the like.

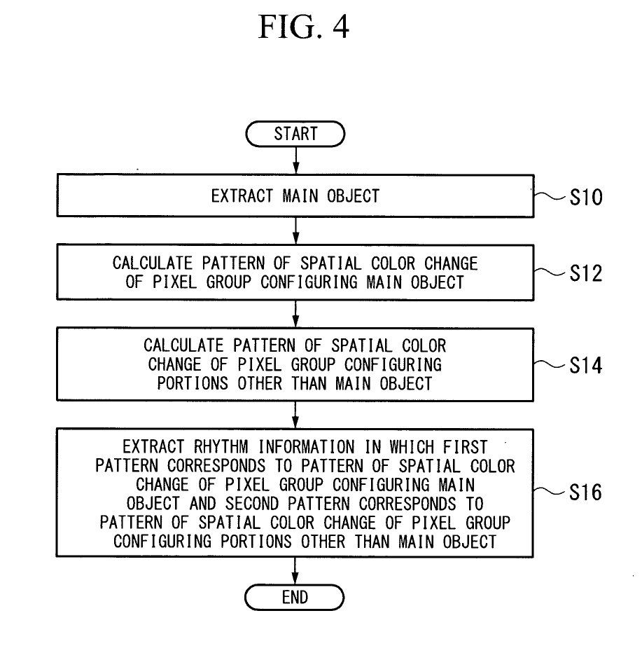

Hereinafter, an operation of the electronic device 1 will be described with reference to a flowchart. FIG. 4 is a flowchart showing an example of the operation of the electronic device 1. Moreover, at the time of starting the flowchart, the rhythm information associated with the combination of the first pattern and the second pattern is set to be stored in the first storage unit 22.

The calculation unit 24 extracts the main object from the captured image (Step S10). The calculation unit 24 calculates the pattern of the spatial color change of the pixel group configuring the main object (Step S12). Specifically, the calculation unit 24 calculates the average pixel value for each pixel group which configures the main object. The calculation unit 24 supplies the pattern of the spatial color change of the pixel group configuring the main object to the selection unit 26.

In addition, the calculation unit 24 calculates the pattern of the spatial color change of the pixel group configuring portions other than the main object (Step S 14). Specifically, the calculation unit 24 calculates the average pixel value for each pixel group which configures portions other than the main object. The calculation unit 24 supplies the pattern of the spatial color change of the pixel group configuring portions other than the main object to the selection unit 26.

The selection unit 26 acquires the pattern of the spatial color change of the pixel group configuring the main object and the pattern of the spatial color change of the pixel group configuring portions other than the main object, from the calculation unit 24, and the selection unit 26 selects the rhythm information, in which the first pattern corresponds to the pattern of the spatial color change of the pixel group configuring the main object and the second pattern corresponds to the pattern of the spatial color change of the pixel group configuring portions other than the main object, from the first storage unit 22 (Step S16), and stores the selected rhythm information in the second storage unit 40. Then, the flowchart ends.

In addition, in the flowchart shown in FIG. 4, after the pattern of the spatial color change of the pixel group configuring the main object is calculated, the pattern of the spatial color change of the pixel group configuring portions other than the main object is calculated. However, after the pattern of the spatial color change of the pixel group configuring portions other than the main object is calculated, the pattern of the spatial color change of the pixel group configuring the main object may be calculated.

As described above, according to the electronic device 1, the rhythm information, which is a numerical value indicating the captured image itself, can be simply acquired from the object. Moreover, the captured images can be simply compared to each other using the rhythm information which is indicated by the numerical value. Moreover, comparison results of the captured images can be utilized for various application processes (for example, grouping of the captured images based on similarity of the captured images, grouping of the imaging devices based on similarity of the captured images by each imaging device, extraction of an object similar to the reference captured image, and extraction of similar points from images different from one another).

Moreover, in the electronic device 1, the pixel group which includes pixels configuring the main object, and the pixel group which includes pixels configuring portions other than the main object are distinguished from each other, and the rhythm information of the captured image is extracted. Accordingly, that is, since the rhythm information of the captured image is extracted considering the pattern of the spatial color change of portions other than the main object in addition to the pattern of the spatial color change of the main object, the rhythm information can be extracted with high accuracy.

In addition, the embodiment is the example in which the information indicating the spatial change in the average pixel value (average value of the pixel values of the plurality pixels in the pixel group) for each pixel group is used as the pattern of the spatial color change of the pixel group. However, the value used as the pattern of the spatial color change of the pixel group is not limited to this. For example, information that indicates a spatial change in a maximum pixel value (maximum value of pixel values of a plurality of pixels in a pixel group) for each pixel group, information that indicates a spatial change in a minimum pixel value (minimum value of pixel values of a plurality of pixels in a pixel group) for each pixel group, information that indicates a spatial change in a medium pixel value (medium value of pixel values of a plurality of pixels in a pixel group) for each pixel group, or the like may be used as the pattern of the color change of the pixel group.

Moreover, instead of the information that indicates the spatial change in the average pixel value (maximum pixel value, minimum pixel value, or medium value of the pixel value) for each pixel group, information, that indicates changes in a frequency region and a time region for each pixel group, may be used as the pattern of the spatial color change of the pixel group. In other words, the pattern of the change in the pixel group (unit region) configured of adjacent pixels having a predetermined number may be the information that extracts the changes in the frequency region and the time region as rhythm, from the information according to each pixel in the pixel group.

Moreover, for example, as a method that extracts the changes in the frequency region and the time region, the changes can be obtained by performing a multi-resolution analysis through a discrete wavelet transform on the imaging information in each pixel in the unit region, and can be obtained by dividing the imaging information in each pixel in the unit region into each frequency band having a certain fixed period and by performing a window Fourier transform on the divided information for each set frequency band. As a result, the image can be a rhythmic change in the frequency region and the time region, and the extraction of characteristics in the rhythm and the comparison thereof are possible.

Moreover, the embodiment has the aspect in which the adjacent pixels having a predetermined number is set to the pixel group, the information indicating the spatial change in the average pixel value (maximum pixel value, minimum pixel value, or medium value of the pixel values) for each pixel group is set to the pattern of the spatial color change of the pixel group, and the rhythm information corresponding to the captured image is extracted based on the pattern. However, the aspect that extracts the rhythm information corresponding to the captured image is not limited to this.

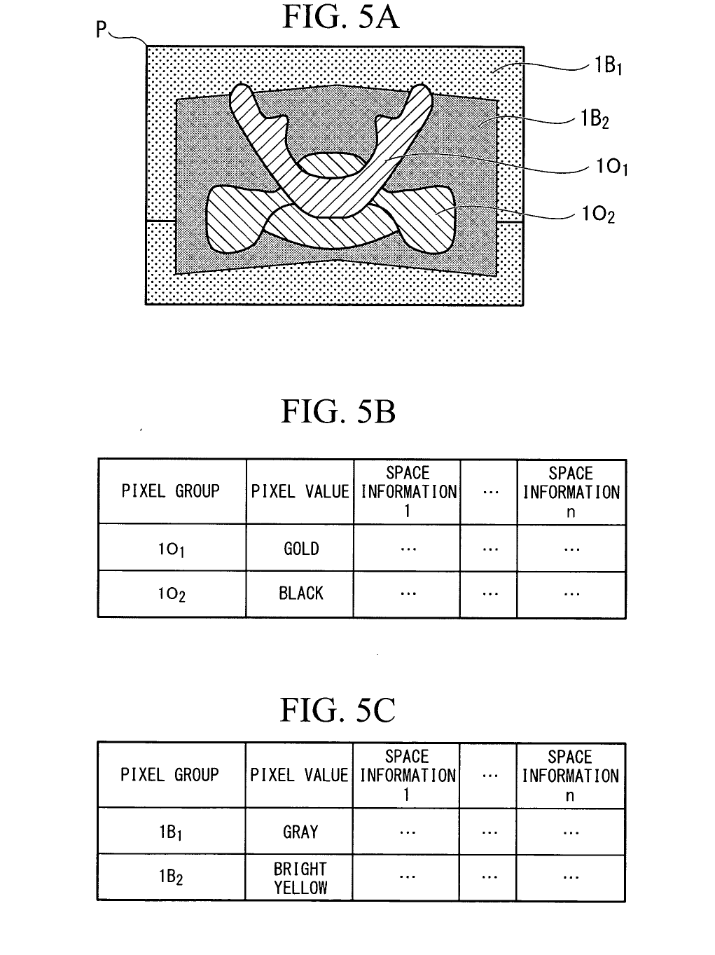

As an example, adjacent pixels, in which a difference of the pixel values is a predetermined value or less, is set to the pixel group, the information indicating the spatial change in the average pixel value (maximum pixel value, minimum pixel value, or medium value of the pixel values) for each pixel group is set to the pattern of the spatial color change of the pixel group, and the rhythm information corresponding to the captured image may be extracted based on the pattern. FIGS. 5A, 5B, and 5C are explanatory diagrams for explaining another process of the extraction unit 20.

FIG. 5A schematically shows that in the pixels configuring the main object (helmet 53) shown in FIGS. 2A, 2B, and 2C, adjacent images in which the difference of the pixel values is a predetermined value or less are set to the pixel group configuring the main object, and in the pixels configuring portions other than the main object, adjacent images in which the difference of the pixel values is a predetermined value or less are set to the pixel group configuring portions other than the main object. Specifically, 1O₁ and 1O₂ are the pixel groups configuring the main object, and 1B₁ and 1B₂ are the pixel groups configuring portions other than the main object. Moreover, a difference between the pixel value (value indicating gray) of the wall surface 51 and the pixel value (value indicating ivory) of the base surface 54 and a difference between the pixel value (value indicating black) of the main body portion of the helmet 53 and the pixel value (value indicating dark blue) of a cloth portion in the inner portion of the main body are predetermined values or less (refer to FIGS. 2A, 2B, and 2C). In addition, in the examples shown in FIGS. 5A, 5B, and 5C, for convenience of explanation, the number of the pixel groups is decreased.

FIG. 5B is an example of the first pattern in the pixel group shown in FIG. 5A. FIG. 5C is an example of the second pattern in the pixel group shown in FIG. 5A. Moreover, in FIGS. 5B and 5C, each value (color) is the average pixel value, but may use the maximum pixel value, the minimum pixel value, or the medium value as described above.

In addition, space information 1 to space information n (n is integer of 1 or more) shown in FIGS. 5B and 5C are the information which defines a spatial position, a size, or the like of each pixel group. As an example of the space information, there is a center coordinate of a circumscribing circle which circumscribes the pixel group, opposing two angles (two angles on a diagonal line) of a circumscribing rectangle which circumscribes the pixel group, or the like. Accordingly, the first pattern shown in FIG. 5B stores the pixel values, the positions, the sizes, or the like of each pixel group configuring the main object, and the second pattern shown in FIG. 5C stores the pixel values, the positions, the sizes, or the like of each pixel group configuring portions other than the main object.

That is, in the extraction unit 20, as shown in FIG. 5A, adjacent pixels in which the difference between pixel values is a predetermined value or less may be set to the pixel group. Moreover, the information, that indicates the spatial change in the average pixel value for each pixel group configuring the main object as shown in FIG. 5B, may be stored as the first pattern, and the information, that indicates the spatial change in the average pixel value for each pixel group configuring portions other than the main object as shown in FIG. 5C, may be stored as the second pattern. Moreover, the rhythm information (not shown) corresponding to the combination of the first and second patterns is stored, and the rhythm information corresponding to the captured image may be extracted based on the information. Also in the case where the rhythm information is extracted, the effects can be obtained, which are similar to the case where the rhythm information is extracted based on the first and second patterns and the rhythm information as shown in FIGS. 2A, 2B, 2C, and 3.

Moreover, if information contents of the space information of FIGS. 5B and 5C are increased, positions and shapes of each pixel group configuring the main object in the image and each pixel group configuring portions other than the main object can be finely represented. That is, the aspect described using FIGS. 5A, 5B, and 5C corresponds to setting the adjacent pixels in which the difference between pixel values is a predetermined value or less as the pixel group, setting the information indicating the spatial change (that is, position and shape of each pixel group) in the distribution of the pixel group as the spatial color change of the pixel group, and extracting the rhythm information corresponding to the captured image based on the pattern.

Moreover, as the information indicating the spatial change in the distribution of the pixel group, for example, instead of the positions and shapes of each pixel group, information with respect to the pixel group for each space may be used. As the information with respect to the pixel group for each space, for example, there is the number of pixel groups, the sizes of each pixel group, the distribution of the color (pixel value), or the like of each pixel group configuring the main object and each pixel group configuring portions other than the main object, for each predetermined region (for example, ¼ region in the upper left, ¼ region in the upper right, ¼ region in the lower left, and ¼ region in the lower right) which is determined in advance in the image.

### Second Embodiment

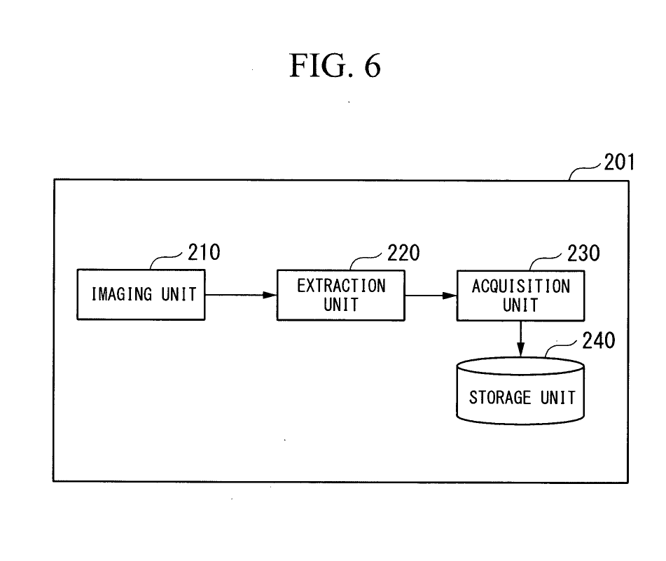

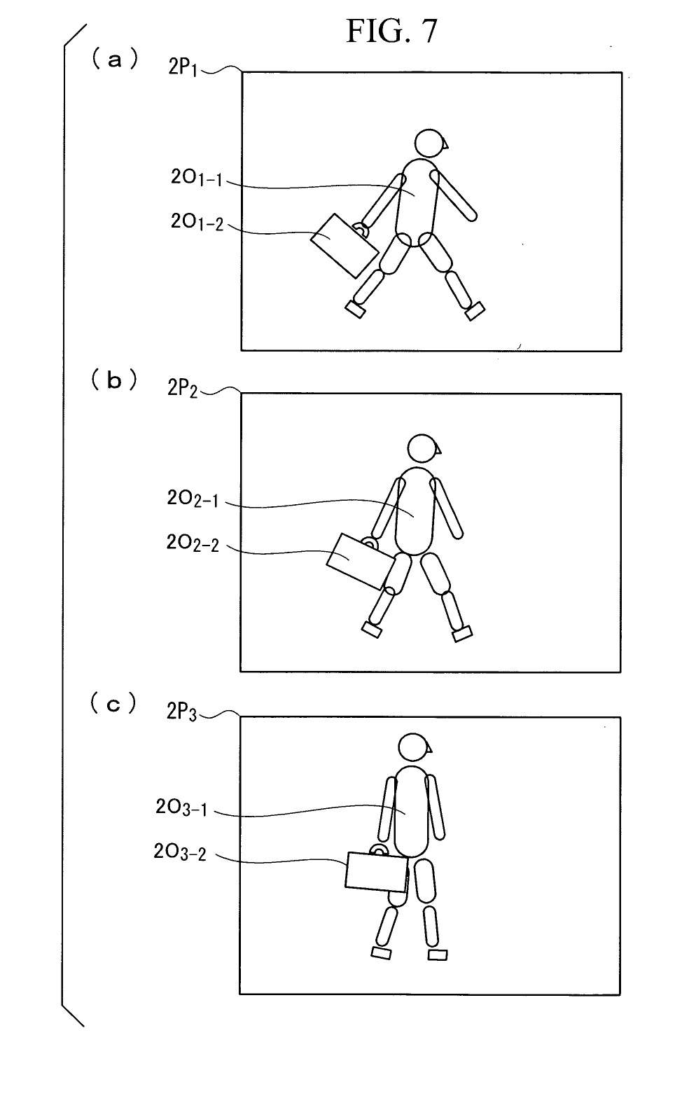

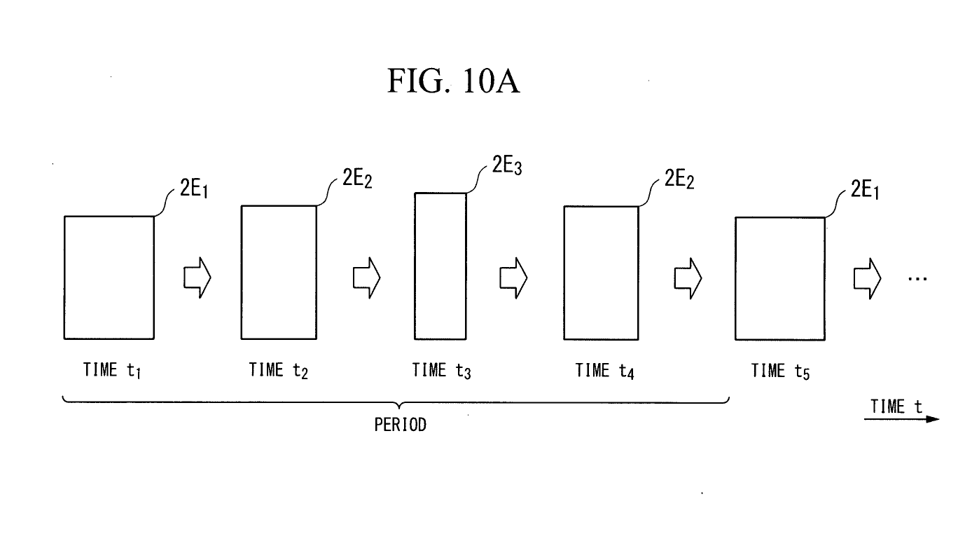

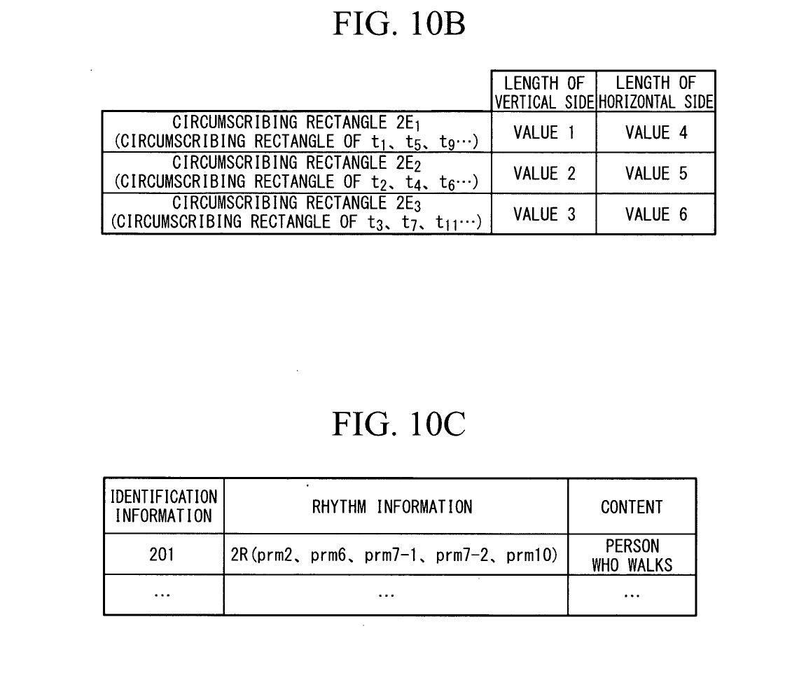

Hereinafter, a second embodiment of the present invention will be described with reference to the drawings. FIG. 6 is a configuration diagram showing an example of an electronic device 201 according to the second embodiment of the present invention. FIGS. 7 to 9 are explantory diagrams for explaining a process of an extraction unit 220. FIGS. 10A, 10B, and 10C are explanatory diagrams for explaining a process of an acquisition unit 230.

For example, the electronic device 201 is a digital camera, and as shown in FIG. 6, includes an imaging unit 210, the extraction unit 220, the acquisition unit 230, and a storage unit 240. The imaging unit 210 is a camera which captures a still image and a moving picture.

The extraction unit 220 extracts an object from an image captured by the imaging unit 210. For example, as shown in FIG. 7, the extraction unit 220 extracts objects (2O₁₋₁, 2O₂₋₁, and 2O₃₋₁) of a main subject (a person who walks with a bag) from moving pictures (2P₁, 2P₂, and 2P₃) captured by the imaging unit 210. 2P₁ shown in FIG. 7(a) is one scene configuring the moving picture and a scene which is captured at the moment when both hands and both legs of the person who is the subject are largely swung. 2P₃ shown in FIG. 7(c) is one scene configuring the moving picture and a scene which is captured at the moment when the person who is the subject is bringing the both hands down. 2P₂ shown in FIG. 7(b) is one scene between 2P₁ and 2P₃. Moreover, objects (2O₁₋₂, 2O₂₋₂, and 2O₃₋₂) are objects of the bag which integrally move with the main subject, and the objects of the bag will be described below.

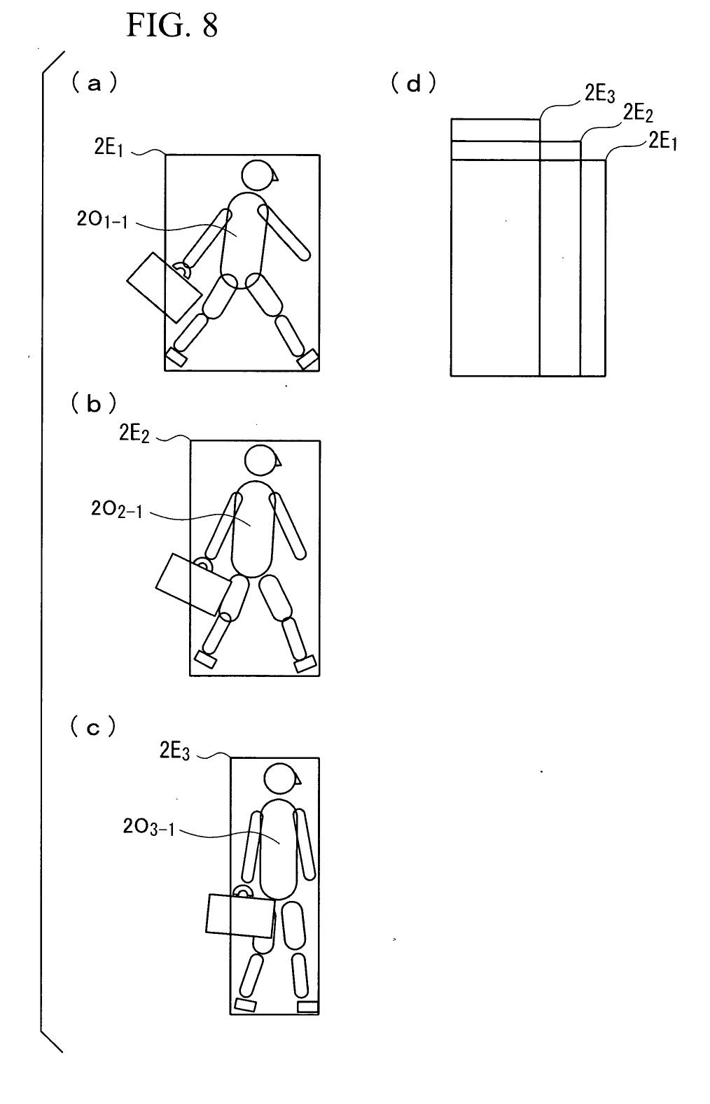

In addition, the extraction unit 220 extracts a graphic (hereinafter, referred to as an object graphic) showing a region of the object which is extracted from the moving picture. For example, as shown in FIG. 8, the extraction unit 220 extracts object graphics (2E₁, 2E₂, and 2E₃) showing the regions of the objects (2O₁₋₁, 2O₂₋₁, and 2O₃₋₁) which are extracted from the moving pictures (2P₁, 2P₂, and 2P₃). 2E₁ shown in FIG. 8(a) is a circumscribing rectangle which circumscribes the object 2O₁₋₁ extracted from 2P₁ shown in FIG. 7(a). 2E₂ shown in FIG. 8(b) is a circumscribing rectangle which circumscribes the object 2O₂₋₁ extracted from 2P₂ shown in FIG. 7(b). 2E₃ shown in FIG. 8(c) is a circumscribing rectangle which circumscribes the object 2O₃₋₁ extracted from 2P₃ shown in FIG. 7(c). In addition, FIG. 8(d) shows a comparison of each size of the circumscribing rectangles 2E₁, 2E₂, and 2E₃.

As shown in FIG. 8(d), when the region of the object related to the subject is changed according to the motion of the subject, the shape of the object graphic (circumscribing rectangle) which is extracted by the extraction unit 220 is temporally changed.

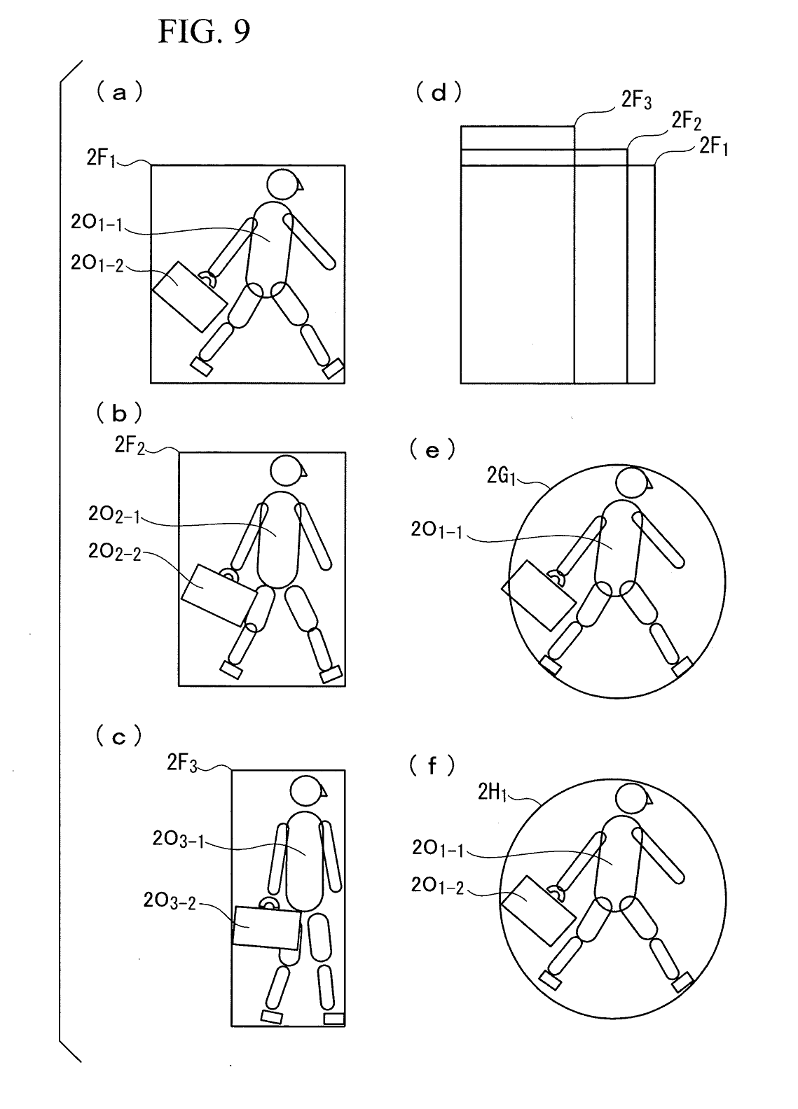

In addition, the extraction unit 220 extracts other subjects which integrally move with the main subject along with the main subject, and may extract an object graphic showing a region of an object which combines the object of the extracted main subject and the object of the other subject. For example, as shown in FIG. 9, the extraction unit 220 may extract object graphics (2F₁, 2F₂, and 2F₃) showing the region of the object which combines the objects (2O₁₋₁, 2O₂₋₁, and 2O₃₋₁) of the main subject (person) and the objects (2O₁₋₂, 2O₂₋₂, and 2O₃₋₂) of other subject (bag), from the moving picture (2P₁, 2P₂, and 2P₃) shown in FIG. 7. 2F₁ shown in FIG. 9(a) is a circumscribing rectangle which circumscribes the object 2O₁₋₁ and the object 2O₁₋₂ which are extracted from 2P₁ shown in FIG. 7(a). 2F₂ shown in FIG. 9(b) is a circumscribing rectangle which circumscribes the object 2O₂₋₁ and the object 2O₂₋₂ which are extracted from 2P₂ shown in FIG. 7(b). 2F₃ shown in FIG. 9(c) is a circumscribing rectangle which circumscribes the object 2O₃₋₁ and the object 2O₃₋₂ which are extracted from 2P₃ shown in FIG. 7(c). Moreover, FIG. 9(d) compares each size of the circumscribing rectangles 2F₁, 2F₂, and 2F₃.

Furthermore, the extraction unit 220 may extract other graphics as the object graphic, instead of the circumscribing rectangle. For example, as shown in FIG. 9(e), the extraction unit 220 may extract a circumscribing circle 2G₁ which circumscribes the region of the object as the object graphic. 2G₁ shown in FIG. 9(e) is a circumscribing circle which circumscribes the object 2O₁₋₁ (also similar in a circumscribing circle which circumscribes the object 2O₂₋₁ and a circumscribing circle which circumscribes the object 2O₃₋₁). In addition, as shown in FIG. 9(f), as the object graphic showing the region of the object which combines the object of the main subject and the object of other subject, the extraction unit 220 may extract other graphics such as the circumscribing circle. 2H₁ shown in FIG. 9(f) is a circumscribing circle which circumscribes the object 2O₁₋₁ and the object 2O₁₋₂ (also similar in a circumscribing circle which circumscribes the object 2O₂₋₁ and the object 2O₂₋₂, and a circumscribing circle which circumscribes the object 2O₃₋₁ and the object 2O₃₋₂).

The acquisition unit 230 acquires a variation of an area, a variation in the length of the long side or the short side (in a case of a circumscribing rectangle), a variation of an aspect ratio (in a case of a circumscribing rectangle), a period of the change in the area, a period of the change in the length (in a case of a circumscribing rectangle), or a period of the change in the aspect ratio (in a case of a circumscribing rectangle) of the object graphic of one object extracted by the extraction unit 220, as rhythm information indicating a temporal change in the object. Moreover, since the rhythm information indicates the temporal change in each object, the rhythm information is a numerical value (index) that indicates the object itself.

When the object graphic is a circumscribing rectangle, the acquisition unit 230 acquires values of one or more parameters among parameters 1 to 12 (hereinafter, referred to as prm 1 to prm 12) exemplified below, as the rhythm information. In addition, when the object graphic is a graphic other than the circumscribing rectangle, the acquisition unit 230 acquires one or more parameters among prm 1 to prm 6 exemplified below, as the rhythm information. Moreover, for example, a predetermined time in prm 1 to prm 12 is a time (for example, one period) based on a period of the shape change of the object graphic. Moreover, the long sides and the short sides in prm 7-1 to prm 9-2 are determined based on the length of a certain reference time (for example, the beginning of one period). In addition, for convenience, simply, a Y axis direction (or an X axis direction) may be determined as the long side.

(Object Graphic=Circumscribing Rectangle and Graphics other than Circumscribing Rectangle)

prm 1: difference between maximum area and minimum area of circumscribing rectangle within a predetermined time

prm 2: area ratio between maximum area and minimum area of circumscribing rectangle within a predetermined time

prm 3-1: difference between average area and maximum area of circumscribing rectangle within a predetermined time

prm 3-2: difference between average area and minimum area of circumscribing rectangle within a predetermined time

prm 4-1: area ratio between average area and maximum area of circumscribing rectangle within a predetermined time

prm 4-2: area ratio between average area and minimum area of circumscribing rectangle within a predetermined time

prm 5: distribution condition (example: standard deviation) of area of circumscribing rectangle within a predetermined time

prm 6: period of change in area of circumscribing rectangle within a predetermined time

prm 7-1: maximum variation of long side of circumscribing rectangle within a predetermined time

prm 7-2: maximum variation of short side of circumscribing rectangle within a predetermined time

prm 8-1: distribution condition (example: standard deviation) of long side of circumscribing rectangle within a predetermined time

prm 8-2: distribution condition (example: standard deviation) of short side of circumscribing rectangle within a predetermined time

prm 9-1: period of change in long side of circumscribing rectangle within a predetermined time

prm 9-2: period of change in short side of circumscribing rectangle within a predetermined time

prm 10: maximum variation of aspect ratio of circumscribing rectangle within a predetermined time

prm 11: distribution condition (example: standard deviation) of aspect ratio of circumscribing rectangle within a predetermined time

prm 12: period of change in aspect ratio of circumscribing rectangle within a predetermined time

Hereinafter, acquisition of the rhythm information by the acquisition unit 230 will be described in detail with reference to FIGS. 10A, 10B, and 10C.

FIG. 10A is an example of the circumscribing rectangle which is sequentially extracted by the extraction unit 220. The circumscribing rectangles 2E₁, 2E₂, and 2E₃ shown in FIG. 10A indicate the circumscribing rectangle 2E₁, the circumscribing rectangle 2E₂, and the circumscribing rectangle 2E₃ shown in FIG. 8. Moreover, FIG. 10B shows sizes of circumscribing rectangles 2E₁, 2E₂, and 2E₃ measured by the acquisition unit 230. In addition, a “period” of FIG. 10A indicates a period of the shape change of object graphics (2O₁₋₁, 2O₂₋₁, and 2O₃₋₁) of the subject (the person who walks with a bag). That is, the person, who walks with a bag, periodically acts with time t, to time t₄ (time t₅ to time t₈, and time t₉ to time t₁₃, and so on) as one period.

The acquisition unit 230 calculates each value shown in FIG. 10B, calculates one or more parameters which have been determined in advance, and acquires a numerical value group, which has the value of each calculated parameter as an element, as the rhythm information of the subject (the person who walks with a bag). For example, the acquisition unit 230 calculates prms 2, 6, 7-1, 7-2, and 10, and acquires the numerical value groups (prm 2, prm 6, prm 7-1, prm 7-2, and prm 10) as the rhythm information of the subject (a person who walks with a bag).

Moreover, thereafter, in the acquisition unit 230, the values of each calculated parameter may be appropriately rounded or may be replaced by other values (may be scored) in order to easily compare the objects.

The acquisition unit 230 stores the acquired rhythm information in the storage unit 240. For example, as shown in FIG. 10C, the acquisition unit 230 stores rhythm information associated with identification information. In addition, the identification information is an index which specifies the rhythm information, and for example, as shown in FIG. 10C, the identification information may be identification information which identifies the object related to the rhythm information. Moreover, in FIG. 10C, a content is information which describes the content (or content of the object) of the rhythm information, and for example, is input via an operation unit (not shown) by a user. The operation unit may be included in the electronic device 201.

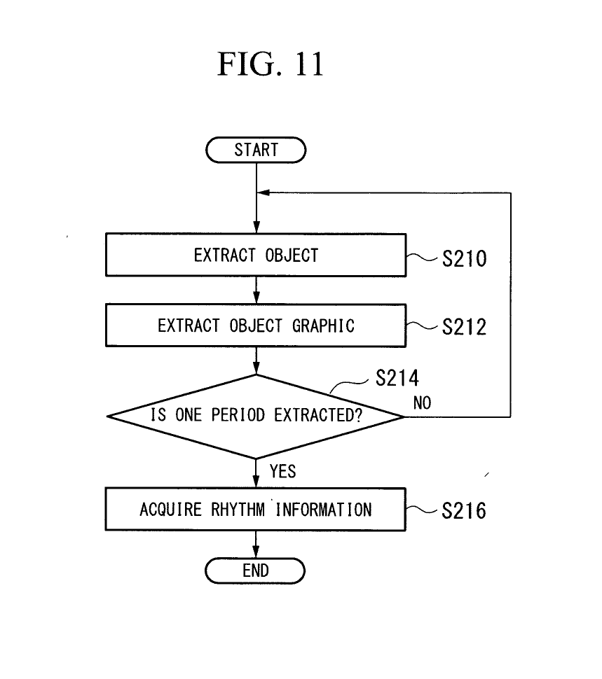

Hereinafter, an operation of the electronic device 201 will be described with reference to a flowchart. FIG. 11 is a flowchart showing an example of the operation of the electronic device 201.

The extraction unit 220 extracts the object from the moving picture (Step S210). The extraction unit 220 extracts the object graphic that indicates the region of the extracted object (Step S212), and temporarily stores the object graphic.

The extraction unit 220 determines whether or not the object graphics of one period have been extracted (Step S214). When the extraction unit 220 determines that the object graphics for one period have not been extracted yet (Step S214: No), it is returned to Step S210. That is, the extraction unit 220 repeats Steps S210 and S212 until periodicity of the change in the object graphics are found.

On the other hand, when the extraction unit 220 determines that the object graphics for one period have been extracted (Step S214: Yes), the acquisition unit 230 acquires the rhythm information based on the object graphics for one period which are temporarily stored (Step S216), and stores the acquired rhythm information in the storage unit 240. Then, the flowchart ends.

In addition, the flowchart shown in FIG. 11 shows the operation in the aspect in which the rhythm information is acquired using the extracted object graphics when object graphics (that is, for one period) necessary for acquiring the rhythm information are extracted (stored) from the sequentially captured moving pictures. That is, the flowchart shown in FIG. 11 shows the operation in the aspect in which the rhythm information is acquired during imaging. However, the aspect of acquiring the rhythm information is not limited to the acquisition during the imaging. For example, after the extraction unit 220 stores all moving pictures, which are sequentially captured, in the storage unit, the acquisition unit 230 may acquire the rhythm information based on the object graphics for one period among all the moving pictures.

As described above, according to the electronic device 201, the rhythm information, which is a numerical value indicating the object itself, can be simply acquired from the object. Moreover, the objects can be simply compared to each other using the rhythm information which is indicated by the numerical value. In addition, comparison results of the objects can be utilized for various application processes (for example, grouping of the objects based on similarity of the objects, grouping of the imaging devices based on similarity of the objects by each imaging device, and extraction of an object similar to the reference object).

### Third Embodiment

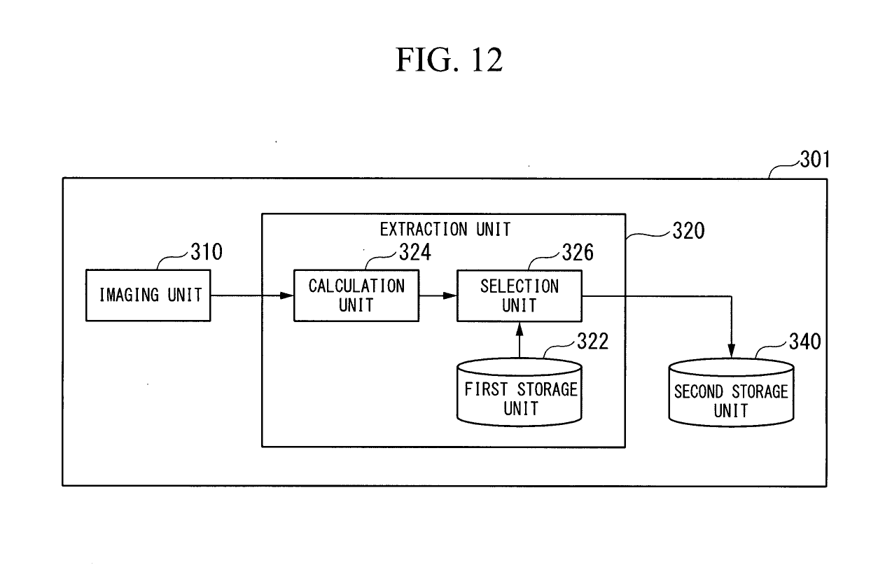

Hereinafter, a third embodiment of the present invention will be described with reference to the drawings. FIG. 12 is a configuration diagram showing an example of an electronic device 301 according to an embodiment of the present invention.

For example, the electronic device 301 is a digital camera, and as shown in FIG. 12, includes an imaging unit 310, the extraction unit 320, and a second storage unit 340. The extraction unit 320 includes a first storage unit 322, a calculation unit 324, and a selection unit 326.

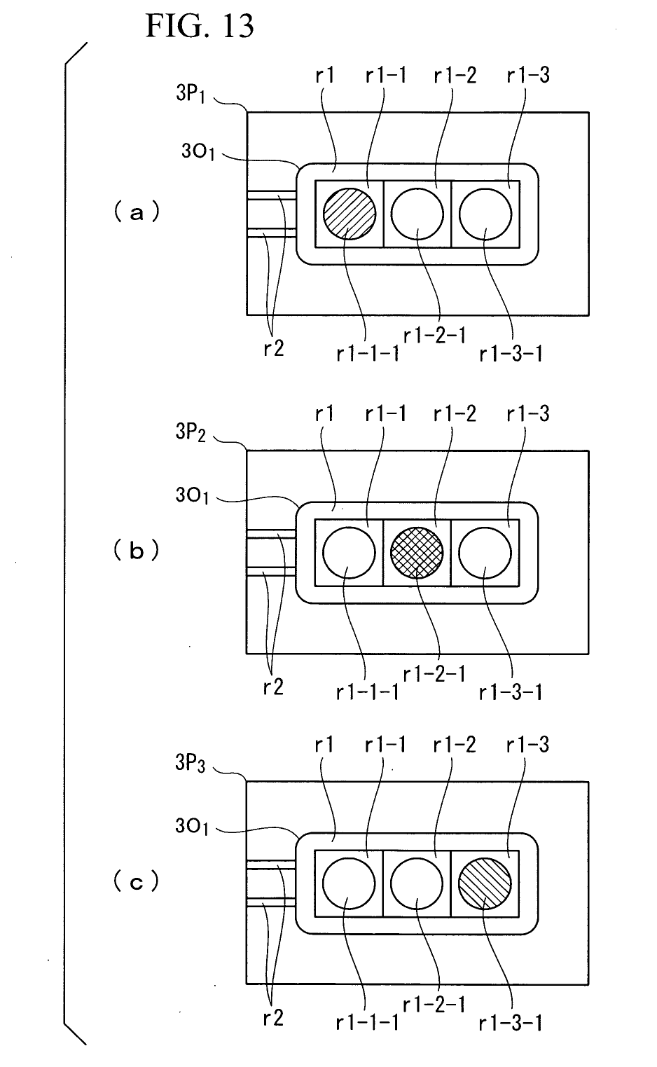

The imaging unit 310 is a camera which captures a still image and a moving picture. The extraction unit 320 extracts an object from a moving picture captured by the imaging unit 310, and extracts rhythm information that indicates a pattern of a change in a color of the object extracted from the moving picture. The second storage unit 340 stores the rhythm information extracted by the extraction unit 320. Hereinafter, a process according to the extraction unit 320 will be described in detail with reference to FIGS. 13 to 15. FIGS. 13 to 15 are explanatory diagrams for explaining the process of the extraction unit 320.

FIG. 13 schematically shows an object (3O₁) of a signal extracted from moving pictures (3P₁, 3P₂, and 3P₃). FIG. 13 (a) shows the object when the signal is blue, FIG. 13(b) shows the object when the signal is yellow, and FIG. 13(c) shows the object when the signal is red. In FIGS. 13(a) to 13(c), r1 indicates an imaging region of a signal main body, and r2 indicates an imaging region of a support portion which supports the signal main body. r1-1 indicates an imaging region of a holding portion which holds a blue lamp in the region in r1, r1-2 indicates an imaging region of a holding portion which holds a yellow lamp in the region in r1, and r1-3 indicates an imaging region of a holding portion which holds a red lamp in the region in r1. r1-1-1 indicates the imaging region of the blue lamp in the region in r1-1, r1-2-1 indicates the imaging region of the yellow lamp in the region in r1-2, and r1-3-1 indicates the imaging region of the red lamp in the region in r1-3.

Moreover, for convenience of explanation, when the signal is blue, the color of the blue lamp during lighting-on is set to bluish green, and the colors of the yellow lamp and the red lamp during lighting-off are set to black. That is, in FIG. 13(a), the color of the region r1-1-1 of the blue lamp is set to bluish green, the color of the region r1-2-1 of the yellow lamp is set to black, and the color of the region r1-3-1 of the red lamp is set to black.

When the signal is yellow, the color of the yellow lamp during lighting-on is set to yellow, and the colors of the blue lamp and the red lamp during lighting-off are set to black. That is, in FIG. 13(b), the color of the region r1-1-1 of the blue lamp is set to black, the color of the region r1-2-1 of the yellow lamp is set to yellow, and the color of the region r1-3-1 of the red lamp is set to black.

When the signal is red, the color of the red lamp during lighting-on is set to red, and the colors of the blue lamp and the yellow lamp during lighting-off are set to black. That is, in FIG. 13(c), the color of the region r1-1-1 of the blue lamp is set to black, the color of the region r1-2-1 of the yellow lamp is set to black, and the color of the region r1-3-1 of the red lamp is set to red.

Moreover, when the signal is any one of blue, yellow, and red, all the regions other than the lamp are set to gray.

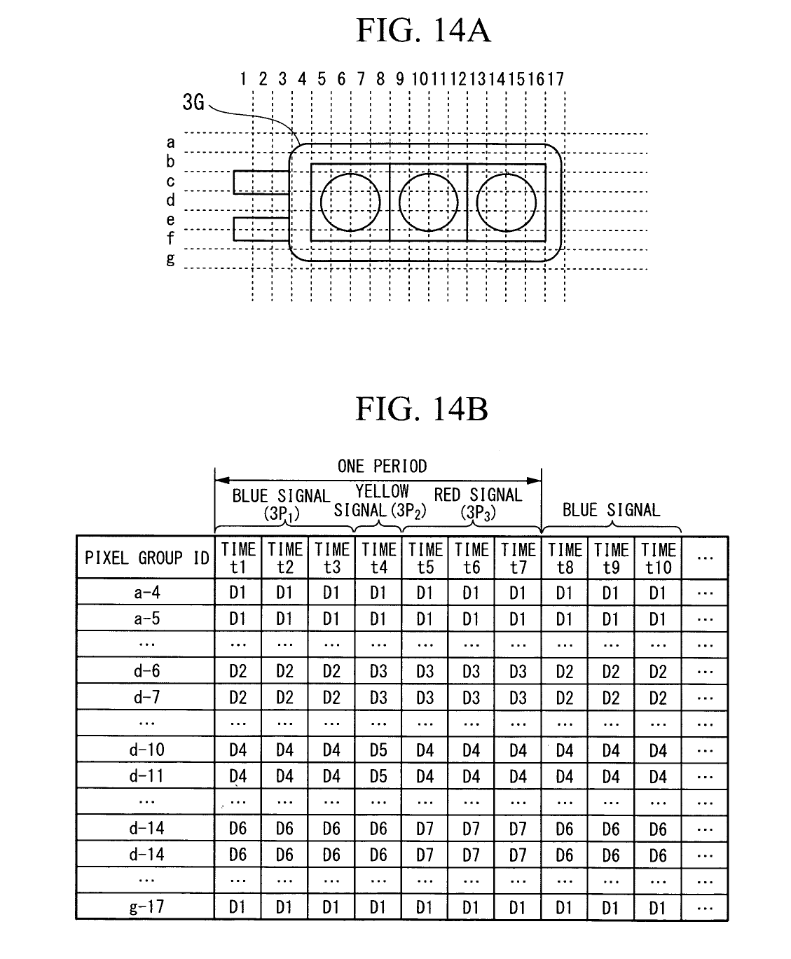

FIG. 14A schematically shows unit regions which configure the object (3O₁) of the signal shown in FIG. 13. The unit region is configured of adjacent pixels having a predetermined number, and is also referred to as the pixel group.

FIG. 14B is the rhythm information “R0001” that indicates the pattern of the color change for each pixel group (that is, for each pixel group shown in FIG. 14A) which configures the object (3O₁) of the signal shown in FIG. 13. The pattern of the color change of the pixel group is the information that indicates the temporal change in the average pixel value (the average value of the pixel values of the plurality of pixels in the pixel group) for each pixel group.

A pixel group ID (a-4, a-5, . . . ) shown in FIG. 14B is the identification information which identifies the pixel group (that is, the pixel group shown in FIG. 14A) which configures the object (3O₁) of the signal shown in FIG. 13. For example, a pixel group ID “a-4” shown in FIG. 14B indicates a pixel group (a pixel group which is defined by an index “4” in a horizontal direction and an index “a” in a vertical direction) of a reference numeral 3G shown in FIG. 14A.

Each time (t1, t2, . . . ) shown in FIG. 14B is imaging timing of the signal shown in FIG. 13. t1 to t3 are the imaging timing when the signal is blue as shown in FIG. 13(a).

t4 is the imaging timing when the signal is yellow as shown in FIG. 13(b). t5 to t7 are the imaging timing when the signal is red as shown in FIG. 13(c). That is, t1 to t7 are one period of the color change of the object (3O₁) of the signal as shown in FIG. 13. Moreover, the time shown in FIG. 14B is time (in general, in a case of an actual signal, the time of blue (and red) is longer than the time of yellow) for convenience of explanation.

Each value (D1 to D7) shown in FIG. 14B is the average pixel value of each pixel group (that is, each pixel group shown in FIG. 14A) which configures the object (3O₁) of the signal shown in FIG. 13, in each imaging timing (t1, t2, . . . ) of the signal as shown in FIG. 13. Moreover, D1 is the pixel value indicating gray, D2 is the pixel value indicating bluish green, D3 is the pixel value indicating black, D4 is the pixel value indicating black, D5 is the pixel value indicating yellow, D6 is the pixel value indicating black, and D7 is the pixel value indicating red.

That is, as described above, FIG. 14B is the rhythm information that indicates the pattern of the color change for each pixel group configuring the object (3O₁) of the signal shown in FIG. 13. Specifically, for example, the rhythm information indicates the following characteristic 1 to characteristic 10, as the color change of the object (3O₁).

Characteristic 1: the color of the region (the region r1-1-1 shown in FIG. 13) positioned at the left side of the center region (the region r1-2-1 shown in FIG. 13) in the region (the region r1 shown in FIG. 13) of a main portion of the object (3O₁) is periodically changed to bluish green (D2) and black (D3).

Characteristic 2: the color of the center region in the region of the main portion of the object (3O₁) is periodically changed to black (D4) and yellow (D5).

Characteristic 3: the color of the region (the region r1-3-1 shown in FIG. 13) positioned at the right side of the center region in the region of the main portion of the object (3O₁) is periodically changed to black (D6) and red (D7).

Characteristic 4: among the region of the main portion of the object (3O₁), the center region, the region positioned at the left side of the center region, and the region positioned at the right side of the center region (regions except for the region r1-1-1, the region r1-2-1, and the region r1-3-1 of the region r1 shown in FIG. 13) are always gray (D1) and the colors do not change.

Characteristic 5: the color of the region (the region r2 shown in FIG. 13) other than the main portion of the object (3O₁) is always gray (D1) and the color does not change.

Characteristic 6: after the region (region r1-1-1) positioned at the left side of the center region is changed from bluish green (D2) to black (D3), the center region (region r1-2-1) is changed from black (D4) to yellow (D5).

Characteristic 7: after the center region (the region r1-2-1) is changed from yellow (D5) to black (D4), the region (the region r1-3-1) positioned at the right side of the center region is changed from black (D6) to red (D7).

Characteristic 8: after the region (region r1-3-1) positioned at the right side of the center region is changed from red (D7) to black (D6), the region (the region r1-1-1) positioned at the left side of the center region is changed from black (D3) to bluish green (D2).

Characteristic 9: the region (region r1-1-1) which is changed to bluish green (D2) and is positioned at the left side of the center region, the center region (region r1-2-1) which is changed to yellow (D5), and the region (region r1-3-1) which is changed to red (D7) and is positioned at the right side of the center region have approximately the same size as one another.

Characteristic 10: a time in which the region (region r1-1-1) positioned at the left side of the center region is bluish green (D2) and a time in which the region (region r1-3-1) positioned at the right side of the center region is red (D7) are the same as each other, and the time is approximately 3 times of the time in which the center region (region r1-2-1) is yellow (D5).

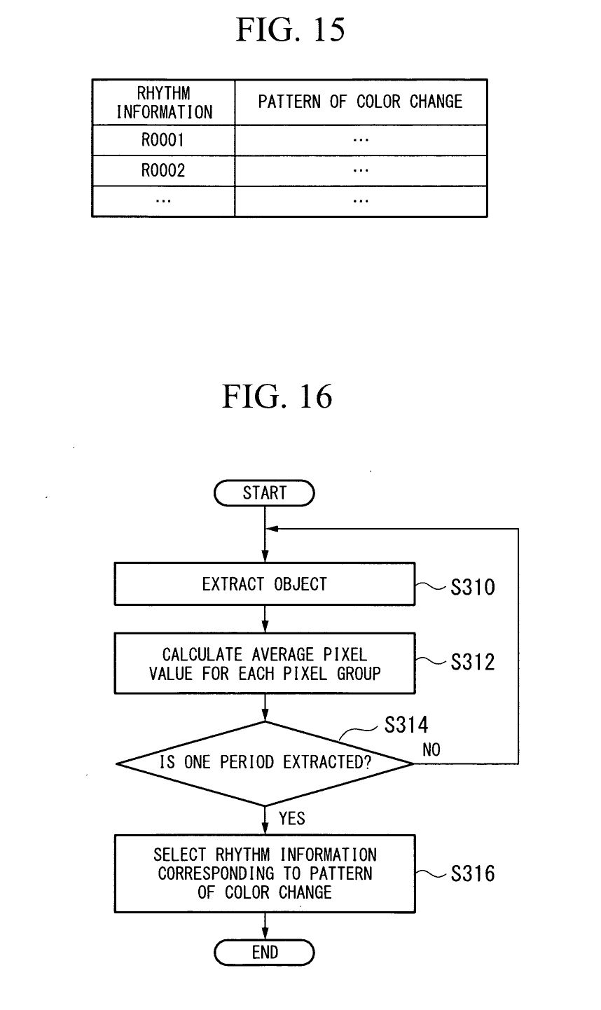

As shown in FIG. 15, the first storage unit 322 stores the pattern of the color change of the pixel group configuring each object according to the rhythm information. For example, the first storage unit 322 stores the pattern of the color change for each pixel group (information indicating the temporal change in the average pixel value for each pixel group) which configures the object (3O₁) shown in FIG. 148, according to the rhythm information “R0001” of the object (3O₁) of the signal shown in FIG. 13.

Moreover, the information (the pattern of the color change for each pixel group configuring the object) stored by the first storage unit 322 may be the information which is prepared by the electronic device 301, the information which is acquired by the electronic device 301 from the outside, or the information which is input by a user of the electronic device 301. Moreover, as an aspect which is prepared by the electronic device 301, the calculation unit 324 calculates the pattern of the color change of the pixel group configuring the object based on a moving picture (may be the moving picture captured by the imaging unit 310) which is set to a sample in advance, and stores the calculated pattern in the first storage unit 322.

As shown in FIG. 15, in a state where the pattern of the color change of the pixel group configuring each object is stored in the first storage unit 322 according to the rhythm information, the calculation unit 324 extracts the object (for example, the object captured in the center region) from the moving picture (each scene) which is sequentially captured by the imaging unit 310.

The calculation unit 324, which extracts the object in each imaging timing, calculates the average pixel value for each pixel group configuring the object in each imaging timing. That is, the calculation unit 324 calculates the pattern of the color change of the pixel group configuring the object. The calculation unit 324, which calculates the pattern of the color change of the pixel group configuring the object, supplies the calculated pattern of the color change to the selection unit 326.

The selection unit 326, which acquires the pattern of the change from the calculation unit 324, selects the rhythm information corresponding to the pattern of the change from the first storage unit 322. More specifically, the selection unit 326 compares one period of the pattern of the change acquired from the calculation unit 324 and one period of the pattern of the change for each rhythm information stored in the first storage unit 322, selects one pattern of the change which coincides with or is most similar to the pattern of the change acquired from the calculation unit 324, and acquires the rhythm information corresponding to the selected pattern of the change. The selection unit 326 stores the acquired rhythm information in the second storage unit 340. In addition, the rhythm information stored in the second storage unit 340 is used for comparison of the objects, or the like.

Hereinafter, an operation of the electronic device 301 will be described with reference to a flowchart. FIG. 16 is a flowchart showing an example of the operation of the electronic device 301. Moreover, at the time of starting the flowchart, the pattern of the color change of the pixel group, which is associated with the rhythm information and configures each object, is set to be stored in the first storage unit 322.

The calculation unit 324 extracts the object from the moving picture (Step S310). The calculation unit 324 calculates the average pixel value for each pixel group configuring the extracted object (Step S312), and the average pixel value is associated with the imaging timing (time) so as to be temporarily stored.

The calculation unit 324 determines whether or not the color change of the object for one period has been extracted (Step S314). In other words, the calculation unit 324 determines whether or not the periodicity with respect to the pattern of the color change of the pixel group configuring the object has been found. When the calculation unit 324 determines that the color change of the object for one period has not been extracted yet (Step S314: No), it is returned to S310. That is, the calculation unit 324 repeats Steps S310 and S312 until periodicity in the color change is found.

On the other hand, when the calculation unit 324 determines that the color change of the object for one period have been extracted (Step S314: Yes), the temporarily stored average pixel value (the pattern of the color change of the pixel group configuring the object) for each pixel group configuring the object is supplied to the selection unit 326 in each imaging timing.

The selection unit 326, which acquires the pattern of the change from the calculation unit 324, selects the rhythm information corresponding to the pattern of the change from the first storage unit 322 (Step S316), and stores the selected rhythm information in the second storage unit 340. Then, the flowchart ends.

In addition, the flowchart shown in FIG. 16 shows the operation in the aspect which calculates the pattern of the color change of the pixel group, which configures the object, using the extracted object when the color change of the object for one period is extracted (stored) from the sequentially captured moving pictures. That is, the flowchart shown in FIG. 16 shows the operation in the aspect in which the rhythm information is extracted during imaging. However, the aspect of extracting the rhythm information is not limited to the extraction during the imaging. For example, after the extraction unit 320 stores all moving pictures, which are sequentially captured, in the first storage unit 322, the calculation unit 324 and the selection unit 326 may extract the rhythm information based on the object graphics for one period among all the moving pictures.

As described with reference to FIGS. 12 to 16, according to the electronic device 301, the rhythm information, which is the numerical value indicating the object itself, can be simply acquired from the object. Moreover, the objects can be simply compared to each other using the rhythm information which is indicated by the numerical value. In addition, comparison results of the objects can be utilized for various application processes (for example, grouping of the objects based on similarity of the objects, grouping of the imaging devices based on similarity of the objects by each imaging device, and extraction of an object similar to the reference object).

Moreover, the embodiment is the example in which the information indicating the temporal change in the average pixel values (the average value of the pixel value of the plurality of pixels in the pixel group) for each pixel group is used as the pattern of the color change of the pixel group. However, the value used as the pattern of the color change of the pixel group is not limited to this. For example, information that indicates the temporal change in the maximum pixel value for each pixel group (the maximum value of the pixel values of the plurality of pixels in the pixel group), information that indicates the temporal change in the minimum pixel value for each pixel group (the minimum value of the pixel values of the plurality of pixels in the pixel group), information that indicates the temporal change in the medium value of the pixel value for each pixel group (the medium value of the pixel values of the plurality of pixels in the pixel group), or the like may be used as the pattern of the color change of the pixel group.

Moreover, the embodiment is the aspect in which adjacent pixels having a predetermined number are set to a pixel group, the information indicating the temporal change in the average pixel value (the maximum pixel value, the minimum pixel value, or the medium value of the pixel value) for each pixel group is set to the pattern of the color change of the pixel group, and the rhythm information corresponding to the color change of the pixel group is extracted. However, the aspect, which extracts the rhythm information corresponding to the color change of the pixel group, is not limited to this.

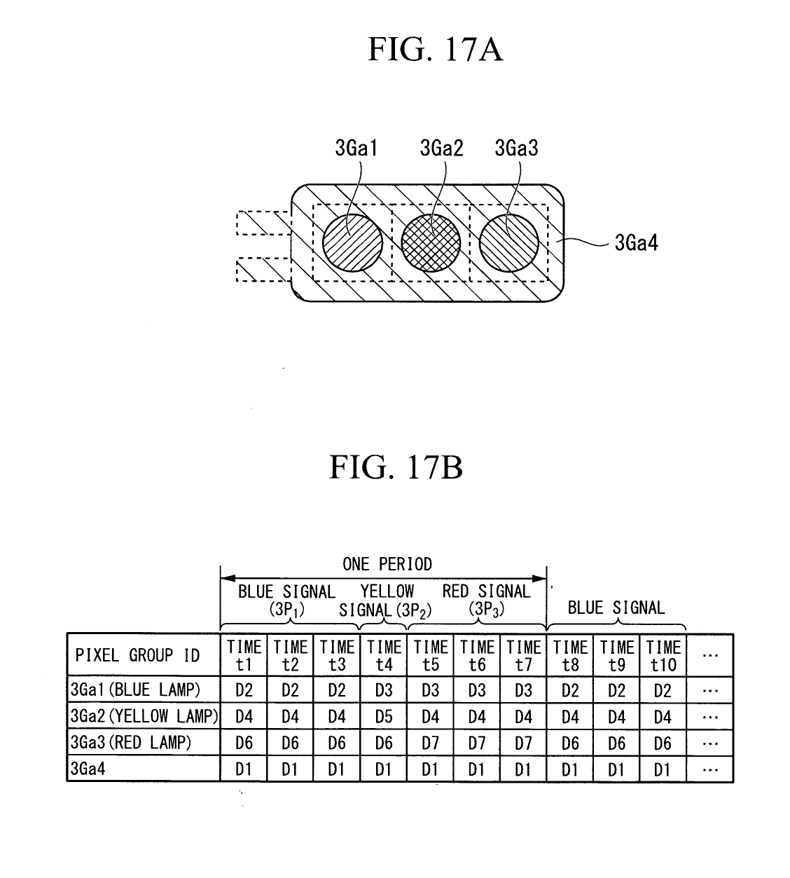

As an example, adjacent pixels, in which the difference between pixel values is a predetermined value or less, are set to a pixel group, the information indicating the temporal change in the average pixel value (the maximum pixel value, the minimum pixel value, or the medium value of the pixel value) for each pixel group is set to the pattern of the color change of the pixel group, and thus, the rhythm information corresponding to the color change of the pixel group may be extracted. FIGS. 17A and 17B are explanatory diagrams for explaining another process of the extraction unit 320.

In FIG. 17A, the adjacent images, in which the difference between pixel values is a predetermined number or less, are schematically shown as the pixel group, in the pixels configuring the object (3O₁) of the signal shown in FIG. 13. In FIG. 17A, 3Ga1 to 3Ga4 are pixel groups of adjacent images in which the difference between the pixel values is a predetermined value or less in all imaging timing (t1 to t7) (refer to FIG. 14B). Specifically, 3Ga1 indicates the region r1-1-1 of the blue lamp, 3Ga2 indicates the region r1-2-1 of the yellow lamp, 3Ga3 indicates the region r1-3-1 of the red lamp, and 3Ga4 indicates the region other than the lamps (refer to FIG. 13).

FIG. 17B is rhythm information “R0001′” that indicates the pattern of the temporal color change for each pixel group (for each pixel group shown in FIG. 17A) configuring the object (3O₁) of the signal shown in FIG. 13. In addition, each value (D1 to D7) is the average value of the pixel values of the plurality of pixels in the pixel group, and is similar to FIG. 14B. However, as described above, instead of the average value, the maximum pixel value (the maximum value of the pixel values of the plurality of pixels in the pixel group), the minimum pixel value (the minimum value of the pixel values of the plurality of pixels in the pixel group), and the medium value (the medium value of the pixel values of the plurality of pixels in the pixel group) may be used.

That is, as shown in FIGS. 17A and 17B, in the extraction unit 320, the adjacent pixels, in which the difference between the pixel values is a predetermined value or less, may be set to the pixel group. Moreover, the information indicating the temporal change in the average pixel value (maximum pixel value, minimum pixel value, or medium value of pixel values) for each pixel group is set to the pattern of the color change of the pixel group, and the rhythm information corresponding to the color change of the pixel group may be extracted. Also in the case where the extraction unit 320 extracts the rhythm information as shown in FIGS. 17A and 17B, the effects similar to the case where the rhythm information is extracted as shown in FIGS. 14A and 14B can be obtained.

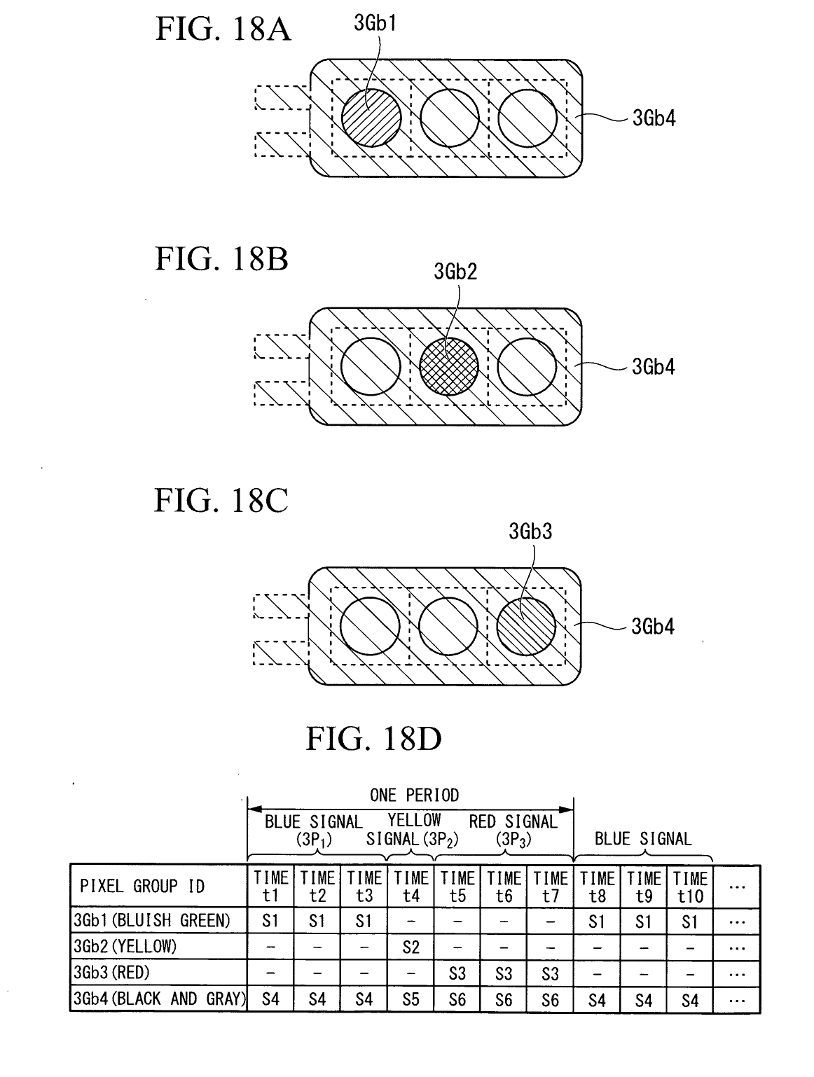

As another example, the rhythm information corresponding to the color change of the pixel group may be extracted by setting the adjacent pixels, in which the difference between the pixel values is a predetermined value or less, as the pixel group, and setting the information indicating the temporal change in the distribution of the pixel groups as the pattern of the color change of the pixel group. FIGS. 18A, 18B, 18C, and 18D are explanatory diagrams for explaining another process of the extraction unit 320.

In FIG. 18A, the adjacent images, in which the difference between pixel values is a predetermined number or less, are schematically shown as the pixel group among the pixels configuring the object (3O₁) of the signal shown in FIG. 13. In FIG. 18A, 3Gb1 and 3Gb4 are pixel groups having adjacent images in which the difference between the pixel values is a predetermined number or less in the imaging timing (t1 to t3) when the signal is blue (refer to FIG. 14B). Specifically, 3Gb1 indicates the blue region, and 3Gb4 indicates the black region and the gray region (refer to FIG. 13). That is, the difference between the pixel value (value that indicates black) of the regions of the yellow lamp and the red lamp during lighting-off and the pixel value (value that indicates gray) of the regions other than the lamps is set so as to be a predetermined value or less.

In FIG. 18B, 3Gb2 and 3Gb4 are pixel groups having adjacent images in which the difference between the pixel values is a predetermined number or less in the imaging timing (t4) when the signal is yellow (refer to FIG. 14B). Specifically, 3Gb2 indicates the yellow region, and 3Gb4 indicates the black region and the gray region (refer to FIG. 13). That is, the difference between the pixel value (value that indicates black) of the regions of the blue lamp and the red lamp during lighting-off and the pixel value (value that indicates gray) of the regions other than the lamps is set so as to be a predetermined value or less.

In FIG. 18C, 3Gb3 and 3Gb4 are pixel groups having adjacent images in which the difference between the pixel values is a predetermined number or less in the imaging timing (t5 to t7) when the signal is red (refer to FIG. 14B). Specifically, 3Gb3 indicates the red region, and 3Gb4 indicates the black region and the gray region (refer to FIG. 13). That is, the difference between the pixel value (value that indicates black) of the regions of the blue lamp and the yellow lamp during lighting-off and the pixel value (value that indicates gray) of the regions other than the lamps is set so as to be a predetermined value or less.

FIG. 18D is rhythm information “R0001” that indicates the pattern of the temporal change in the distribution for each pixel group (for each of the pixel groups shown in FIGS. 18A to 18C) configuring the object (3O₁) of the signal shown in FIG. 13.

Each value (S1 to S7) in the Table of FIG. 18D indicates the distribution (shape of the region) of each pixel group in each imaging timing. Specifically, S1 indicates the distribution of the region r1-1-1 of the blue lamp, S2 indicates the distribution of the region r1-2-1 of the yellow lamp, S3 indicates the distribution of the region r1-3-1 of the red lamp, S4 indicates the distribution of the region other than the blue lamp, S5 indicates the distribution of the region other than the yellow lamp, and S6 indicates the distribution of the region other than the red lamp.

That is, as shown in FIGS. 18A, 18B, 18C, and 18D, in the extraction unit 320, the rhythm information corresponding to the color change of the pixel group may be extracted by setting the adjacent pixels, in which the difference between the pixel values is a predetermined value or less, as the pixel group, and setting the information indicating the temporal change in the distribution of the pixel groups as the pattern of the color change of the pixel group. Also in the case where the rhythm information is extracted as shown in FIGS. 18A, 18B, 18C, and 18D, the effects similar to the case where the rhythm information is extracted as shown in FIGS. 14A and 14B can be obtained.

As described above, according to the electronic device 301, the rhythm information, which is a numerical value indicating the object itself, can be simply acquired from the object. Moreover, the aspect shown in FIGS. 14A and 14B is an aspect in which the pattern of the color change in the pixel group is set to the rhythm information. However, the pattern of the color change may represent the pattern of the change which includes any one or two or more of hue, chroma, brightness, chromaticity, and contrast (ratio) (the aspect shown in FIGS. 17A and 17B is also similar). For example, in the aspects shown in FIGS. 14A, 14B, 17A, and 17B, the pattern of the change in the contrast for each pixel group (that is, chronological changes of luminance, light/dark for each pixel group) may be set to the rhythm information. Moreover, for example, in the aspects shown in FIGS. 14A, 14B, 17A, and 17B, the pattern of the change in the contrast between pixel groups (that is, chronological changes of the differences of luminance, light/dark between pixel groups) may be set to the rhythm information (the aspect shown in FIGS. 17A and 17B also is similar). In addition, the aspect shown in FIGS. 17A and 17B is an aspect in which the adjacent images, in which the difference between the pixel values is a predetermined number or less, are set to the pixel group. However, the pixel value may represent any one or one or more of hue, chroma, brightness, chromaticity, and contrast (ratio) (the aspect shown in FIGS. 18A, 18B, 18C, and 18D also is similar). For example, in the aspects shown in FIGS. 17A, 17B, 18A, 18B, FIG. 18C, and FIG. 18D, the adjacent images, in which the difference of the contrast (luminance, light/dark) is a predetermined number or less, may be set to the pixel group.

Moreover, the aspect shown in FIGS. 18A, 18B, 18C, and 18D is an aspect in which the temporal change in the distribution of the pixel group is set to the rhythm information. However, the rhythm information also represents the shape change of each portion (each pixel group) configuring the object. For example, as shown in FIGS. 18A, 18B, 18C, and 18D, the rhythm information indicates the periodic shape change of the pixel group 3Gb4.

In addition, the aspect shown in FIGS. 18A, 18B, 18C, and 18D also represents the disposition change of each portion (each pixel group) configuring the object. For example, when the pixel group 3Gb1 and the pixel group 3Gb3 have the same pixel group (both groups are set to 3Gb1) (for example, 3Gb3 is not red but blue), the rhythm information represents the periodic disposition change of the pixel group 3Gb1.

In addition, as shown in FIG. 12, the embodiment is the aspect in which the rhythm information is directly extracted from the moving picture captured by the imaging unit 310. However, according to the conditions of external light, by filtering the light (correcting the color) to be a state where the reference light (light having a predetermined color temperature, for example, natural light) contacts, and the rhythm information may be extracted from the moving picture after the filtering.

Specifically, the electronic device 301 may further include a correction unit 311 (not shown) which corrects the color of the moving picture captured by the imaging unit 310. That is, the correction unit 311 may correct the color of the moving picture captured by the imaging unit 310 to the color obtained in a case the moving picture was captured under the predetermined reference light and may output the corrected color to the extraction unit 320, and the extraction unit 320 may extract the rhythm information from the moving picture which is corrected by the correction unit 311. Accordingly, stable rhythm information can be extracted regardless of the conditions of the external light when the moving picture is captured.

### Fourth Embodiment

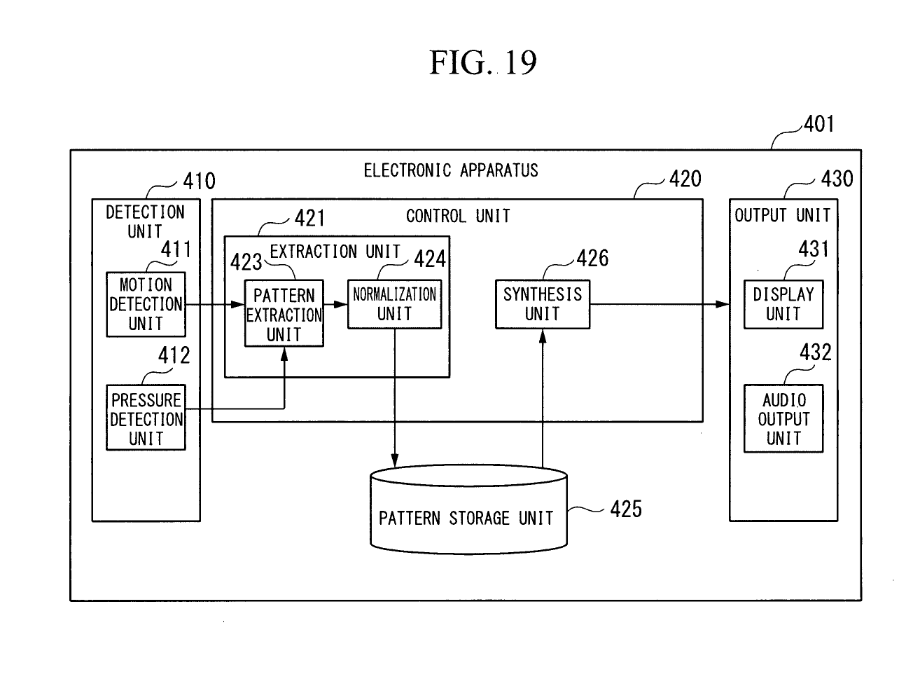

Hereinafter, a fourth embodiment of the present invention will be described in detail with reference to the drawings. FIG. 19 is a block configuration diagram of an electronic apparatus 401 according to the present embodiment.

The electronic apparatus 401 includes a detection unit 410, a control unit 420, a pattern storage unit 425, and an output unit 430.

First, an outline of the electronic apparatus 401 of the present embodiment will be described. When the electronic apparatus 401 is grasped and swung by an operator, the electronic apparatus detects the motion of the electronic apparatus and the pressure which is applied to the side surfaces of the electronic apparatus, extracts the patterns of signals, which repeatedly appear, from the signal indicating the detected motion and the signal indicating the pressure, and synthesize the extracted patterns. Accordingly, in the electronic apparatus 401, variation in the synthesized pattern can be increased by synthesizing the plurality of patterns, the synthesized pattern is informed to the outside via the output unit 430, and thus, the information detected by the electronic apparatus can be expressed in expressive way.

Hereinafter, processes of each unit will be described. The detection unit 410 detects a plurality of signals that indicates characteristics (for example, the motion of the electronic apparatus and the pressure which is applied to the side surfaces of the electronic apparatus) of a detection target (for example, the electronic apparatus itself) from the detection target. Here, the detection unit 410 includes a motion detection unit 411 and a pressure detection unit 412.

The motion detection unit 411 detects the motion of the electronic apparatus and supplies signals indicating the detected motion to a pattern extraction unit 423. Specifically, for example, the motion detection unit 411 detects the motion of the electronic apparatus when the electronic apparatus is grasped and operated by the operator. For example, an acceleration sensor is provided as the motion detection unit 411.

The pressure detection unit 412 is disposed on the side surfaces of the electronic apparatus 401, detects the pressure which is applied to the side surfaces, and outputs signals indicating the detected pressure to the pattern extraction unit 423. Specifically, for example, the pressure detection unit 412 detects the pressure, which is applied to the side surfaces of the electronic apparatus, by predetermined stages (for example, 256 stages) when the electronic apparatus is grasped and moved by the operator. For example, if the pressure detection unit 412 is divided into 5 points, the pressure detection unit 412 can detect the pressure at 5 points.

For example, a capacitance type pressure sensitive sensor is provided as the pressure detection unit 412.

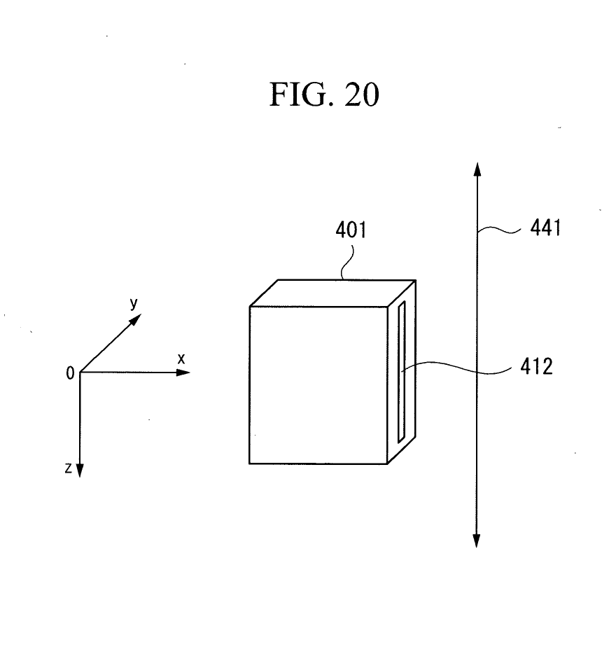

The process of the motion detection unit 411 and the pressure detection unit 412 will be described with reference to a specific example of FIG. 20.

FIG. 20 is a diagram for explaining a direction in which the electronic apparatus 401 is grasped and swung by the operator (user) of the electronic apparatus. In a xyz coordinate system in FIG. 20, a direction 441 in which the electronic apparatus 401 is swung is shown, and it is shown that the electronic apparatus 401 is swung in the z axis direction. Moreover, the pressure detection unit 412 is provided on the side surface of the electronic apparatus 401.

For example, in the example of FIG. 20, the motion detection unit 411 includes a three-dimensional acceleration sensor and detects acceleration of three axes (x, y, and z axes). The motion detection unit 411 outputs signals indicating acceleration of three axes to the pattern extraction unit 423, which will be described below, of the control unit 420.

The pressure detection unit 412 detects the pressure applied to the side surface of the electronic apparatus when the electronic apparatus is grasped by the operator (user), and outputs the signals indicating the detected pressure to the pattern extraction unit 423.

Returning to FIG. 19, the control unit 420 includes an extraction unit 421 and the synthesis unit 426. The extraction unit 421 extracts the patterns of the signals, which repeatedly appear, from the plurality of signals detected by the plurality of detection unit (in the present embodiment, the motion detection unit 411 and the pressure detection unit 412). Here, the extraction unit 421 includes a pattern extraction unit 423 and a normalization unit 424.

Subsequently, an outline of a process according to pattern extraction unit 423 will be described. The pattern extraction unit 423 extracts the patterns, which repeatedly appear, as the pattern of the motion and the pattern of the pressure, from the signal indicating the motion and the signal indicating the pressure. The pattern extraction unit 423 outputs the information indicating the extracted pattern of the motion and the information indicating the extracted pattern of the pressure, to the normalization unit 424.

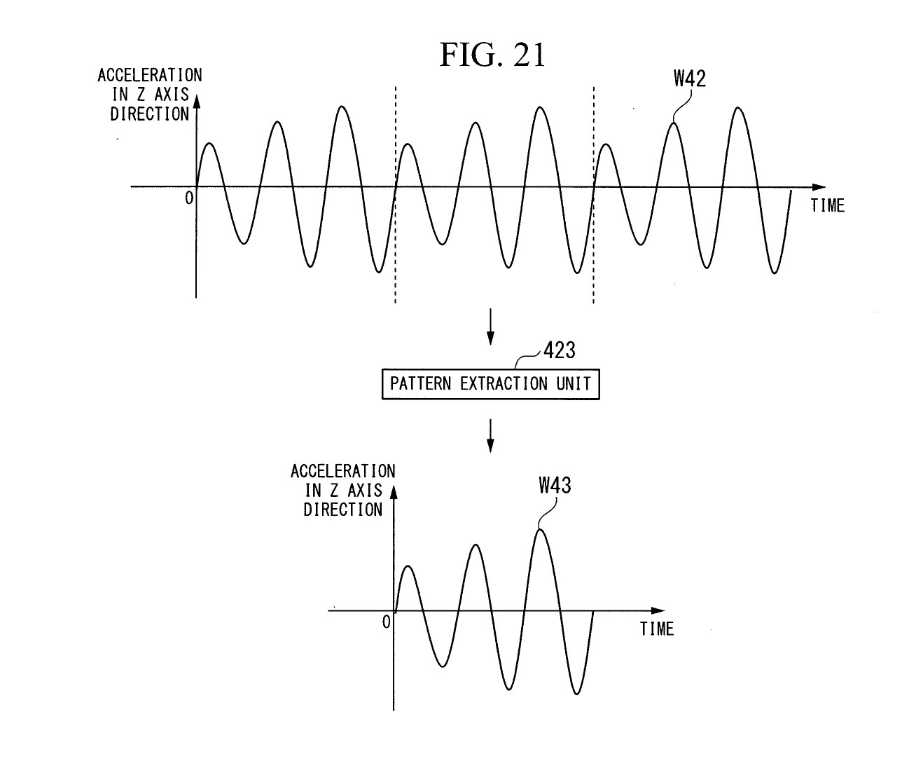

An example of the process of the pattern extraction unit 423 will be described with reference to FIG. 21. FIG. 21 is a diagram for explaining the process of the pattern extraction unit 423. Here, a case where the electronic apparatus is repeatedly swung according to a constant pattern in the z axis direction by an operator (user) is assumed. In addition, in the present embodiment, for easy understanding of explanation, only acceleration in the z axis direction will be described.

In the upper side of FIG. 21, a curve W42 is shown, that indicates a temporal change in the acceleration in the z axis direction detected by the motion detection unit 411. Moreover, the curve W42 is divided into 3 time regions by dashed lines, and it is shown that the temporal change in the acceleration after normalization is repeated in one time region.

In the lower side of FIG. 21, a curve W43 indicating the pattern extracted by the pattern extraction unit 423 is shown. In the example of FIG. 21, the pattern extraction unit 423 extracts the temporal change, which repeatedly appears, as the pattern of the motion, from the signal indicating the motion.

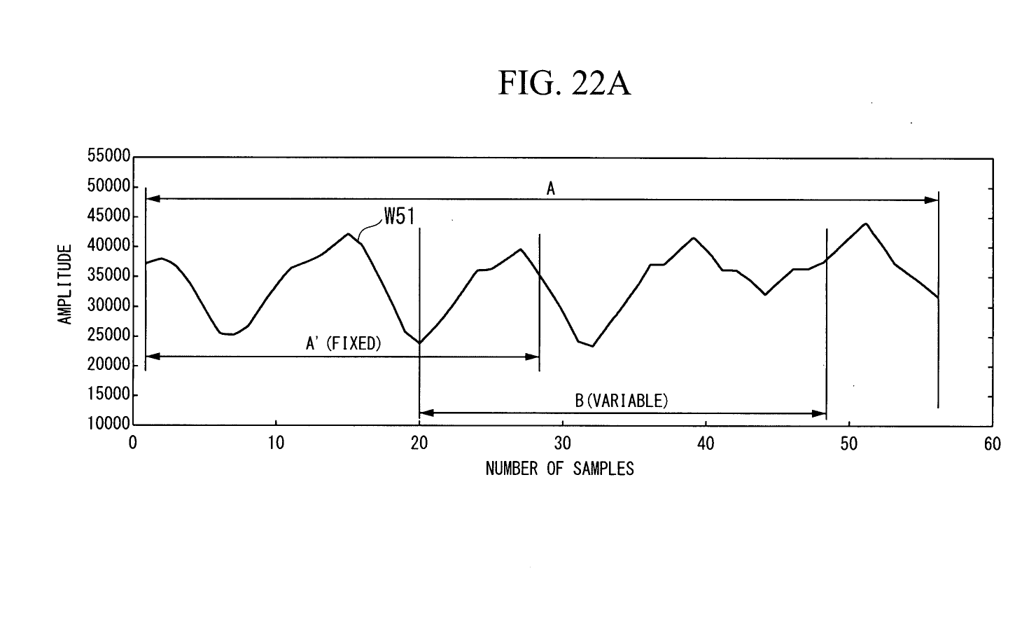

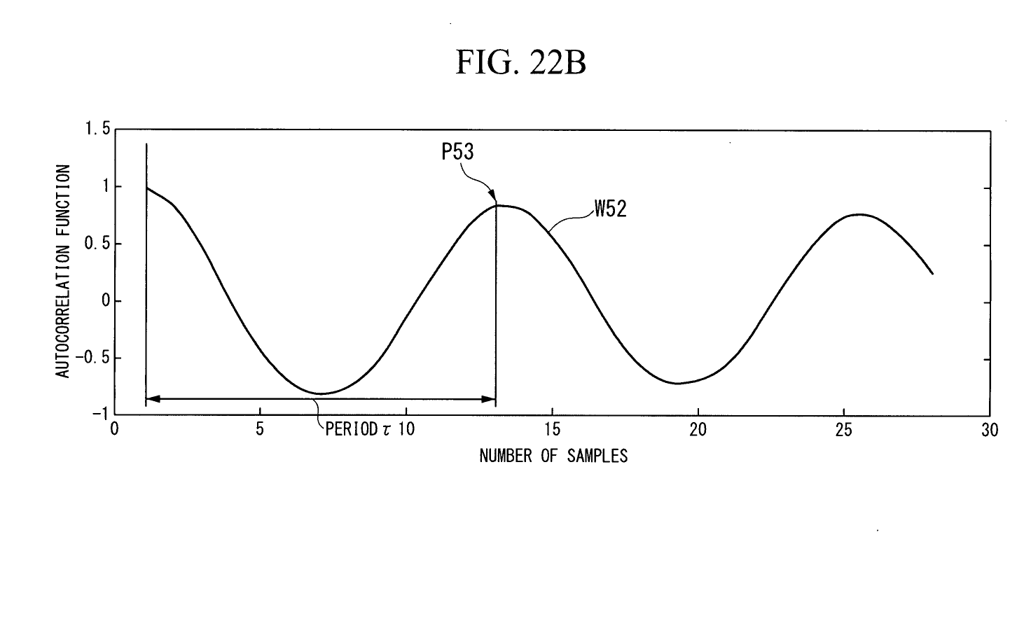

Subsequently, the process of the pattern extraction according to the pattern extraction unit 423 will be described in detail. FIG. 22A is a diagram showing another example of the signal that indicates the motion input to the pattern extraction unit 423. Moreover, FIG. 22B is a diagram showing an autocorrelation function which is calculated by the pattern extraction unit 423. In FIG. 22A, a curve W51, which shows another example of the signal indicating the motion input to the pattern extraction unit 423, is shown. Here, the vertical axis indicates amplitude, and the horizontal axis indicates the number of samples.

In FIG. 22B, an example of a curve W52 is shown, that indicates the autocorrelation function which is calculated from each point configuring the curve W51, by the pattern extraction unit 423. Here, the vertical axis indicates a value of the autocorrelation function, and the horizontal axis indicates the number of samples. Moreover, a peak P53 indicates the maximum value of the autocorrelation function, and period τ indicates that a period from a first sample to the sample of the peak P53.

For example, input data A, which is shown in FIG. 22A and includes n terms input to the pattern extraction unit 423, is represented by the following Equation (1).

[Expression 1]

A={a₁,a₂, . . . ,aₙ} (1)

Moreover, an arrangement A′ of m terms (m=n/2) which is a portion of the arrangement of the input data A shown in FIG. 22A is represented by the following (2) (n is an even number of 2 or more, and m is a positive integer).

[Expression 2]

A′={a₁,a₂, . . . ,aₘ} (2)

Here, A′ is fixed. Moreover, an arrangement B of m terms, in which the arrangement of the input data A shown in FIG. 22A is shifted by t (0≦t≦n/2), is represented by the following Equation (3).

[Expression 3]

B={b₁,b₂, . . . ,bₘ}={a₁₊ₜ,a₂₊ₜ, . . . ,aₘ₊ₜ} (3)

Here, B is a variable.

The pattern extraction unit 423 calculates the autocorrelation function, which is obtained by the shifted width t, according to the arrangement A′ and the arrangement B by the following Equation (4).

$$\begin{matrix}[ Equation 4 ] & \\ R ( t ) = \frac{{\sum }_{i}^{m} ( {a}_{i} - \overline{a} ) ( {b}_{i} - \overline{b} )}{\sqrt{{\sum }_{i}^{m} {( {a}_{i} - \overline{a} )}^{2}} \sqrt{{\sum }_{i}^{m} {( {b}_{i} - \overline{b} )}^{2}}} & ( 4 )\end{matrix}$$

Here, i is an index of the element of each arrangement. Moreover, the value approaches 1 as the wave of the element of the arrangement A′ and the wave of the element of the arrangement B, which are drawn with a predetermined interval, are similar to each other.

The pattern extraction unit 423 extracts concave apex data (peak value) on the autocorrelation function R(t). In addition, when the extracted peak value exceeds a predetermined threshold value, the pattern extraction unit 423 extracts the sample number (or time) which takes the peak value. The pattern extraction unit 423 extracts a sample interval (or time interval) during taking the peak value, as the period τ.

The pattern extraction unit 423 divides the input data A for each one period by the period τ obtained by the autocorrelation function. Moreover, when a repeat count is defined as num, the pattern extraction unit 423 calculates the average data for one period ave(n) according to the following Equation (5).

$$\begin{matrix} [ Equation 5 ] & \\ ave ( n ) = \{ \frac{1}{num} {\sum }_{k = 0}^{num} A ( 1 + k τ ) , \frac{1}{num} {\sum }_{k = 0}^{num} A ( 2 + k τ ) , … , \frac{1}{num} {\sum }_{k = 0}^{num} A ( n + k τ ) \} & ( 5 )\end{matrix}$$

Here, k is an integer. The average data for one period ave(n) is the output data of the pattern extraction unit 423 and corresponds to the curve W43 of FIG. 21. The pattern extraction unit 423 outputs the calculated average data for one period ave(n) to the normalization unit 424 as the information indicating the pattern of the motion. Similarly, also with respect to the pressure, the pattern extraction unit 423 calculates the average data for one period ave(n), and outputs the calculated average data for one period ave(n) to the normalization unit 424 as the information indicating the pattern of the pressure.

The normalization unit 424 normalizes the information indicating the pattern of the motion and the information indicating the pattern of the pressure to a value of a predetermined range (for example, values from −1 to 1) in parallel, and stores the information indicating the pattern of the motion after normalization and the information indicating the pattern of the pressure after normalization in the pattern storage unit 425.

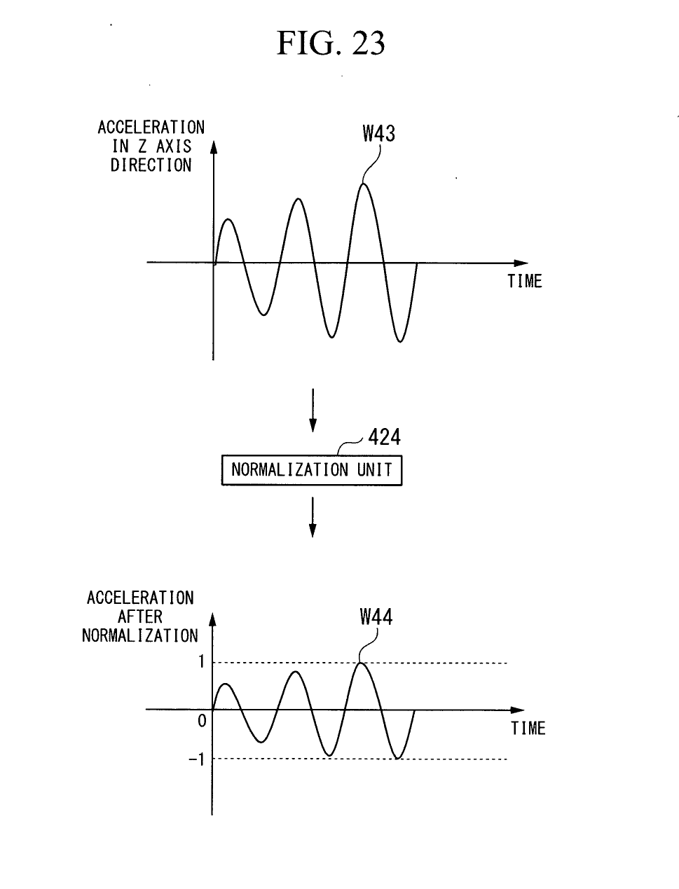

An example of the process of the normalization unit 424 will be described with reference to FIG. 23. FIG. 23 is a diagram for explaining the process of the normalization unit. In the upper side of FIG. 23, the curve W43 indicating the pattern is shown. The vertical axis indicates acceleration in the z axis direction, and the horizontal axis indicates time. In the lower side of FIG. 23, a curve W44 is shown, that indicates the temporal change in the acceleration after the acceleration in the z axis direction is normalized to the values from −1 to 1. The vertical axis indicates the normalized acceleration, and the horizontal axis indicates time.

In the example of FIG. 23, the normalization unit 424 normalizes the signal indicating the acceleration in the z axis direction, among signals indicating the acceleration of three axes, to the values from −1 to 1.

Moreover, in the present embodiment, the normalization unit 424 normalizes the signal indicating the motion and the signal indicating the pressure in parallel. However, the normalization is not limited to this, and may be performed in series. In this case, the normalization unit 424 delays either the signal indicating the motion or the signal indicating the pressure by a delay element included in the normalization unit 424, and thus, may be configured of only hardware. In addition, the normalization unit 424 converts either the signal indicating the motion or the signal indicating the pressure into digital signals, temporarily saves the converted digital signals in a buffer included in the normalization unit 424, sequentially reads the saved digital signals, and thus, may normalize the read digital signals.

The synthesis unit 426 reads the information indicating the pattern of the motion after normalization and the information indicating the pattern of the pressure after normalization, from the pattern storage unit 425. When any amplitude of each pattern is larger than a predetermined threshold value (for example, 0.5), the synthesis unit 426 determines the amplitude of the pattern obtained by the synthesis based on the amplitude of each pattern and synthesizes each pattern.

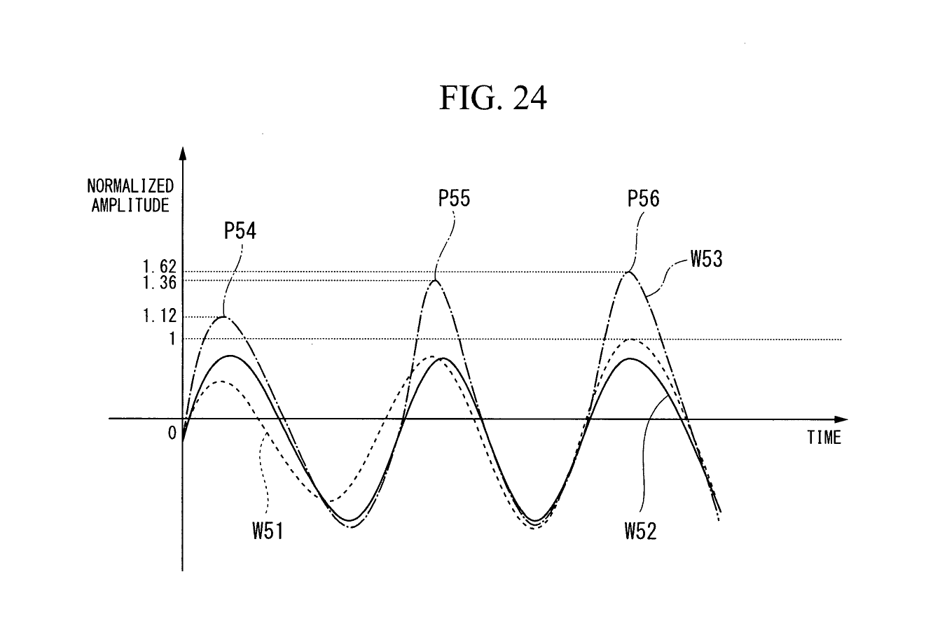

An example of the process of the synthesis unit 426 will be described with reference to FIG. 24. FIG. 24 is a diagram for explaining the process of the synthesis unit 426. In FIG. 24, the vertical axis indicates normalized amplitude, and the horizontal axis indicates time. In FIG. 24, a curve W51 indicating the pattern of the motion after normalization, a curve W52 indicating the pattern of the pressure after normalization, and a curve W53 indicating the synthesized signal after the pattern of the normalized motion and the pattern of the normalized pressure are synthesized by the synthesis unit 426 are shown.

For example, the synthesis unit 426 adds a value 0.6, which is a value on the curve W51 of the pattern of the motion after normalization, and a value 0.8, which is a value on the curve W52 of the pattern of the pressure after normalization, and multiples a coefficient 0.8, which corresponds to the combination (0.6 and 0.8) of the amplitude of each pattern, to the value 1.4 obtained by the addition of the value 0.6 and value 0.8. The obtained value 1.12 is set to the amplitude of a peak P54 on the curve W53 indicating the synthesized signal.

Similarly, for example, the synthesis unit 426 adds a value 0.8, which is on the curve W51 of the pattern of the motion after normalization, and a value 0.8, which is on the curve W52 of the pattern of the pressure after normalization, and multiples a coefficient 0.85, which corresponds to the combination (0.8 and 0.8) of the amplitude of each pattern, to the value 1.6 obtained by the addition of the value 0.8 and value 0.8. The obtained value 1.36 is set to the amplitude of a peak P55 on the curve W53 indicating the synthesized signal.

Similarly, for example, the synthesis unit 426 adds a value 1.0, which is on the curve W51 of the pattern of the motion after normalization, and a value 0.8, which is on the curve W52 of the pattern of the pressure after normalization, and multiples a coefficient 0.9, which corresponds to the combination (1.0 and 0.8) of the amplitude of each pattern, to the value 1.8 obtained by the addition of the value 1.0 and value 0.8. The obtained value 1.62 is set to the amplitude of a peak P56 on the curve W53 indicating the synthesized signal.

The synthesis unit 426 outputs the image data based on the synthesized pattern to a display unit 431, which will be described below, of the output unit 430. Moreover, the synthesis unit 426 generates an electric signal based on the synthesized pattern, and outputs the electric signal to the audio output unit 432.

The output unit 430 informs to the outside of the electronic apparatus based on the pattern synthesized by the synthesis unit 426. Here, the output unit 430 includes the display unit 431 and the audio output unit 432.

The display unit 431 displays the image data based on the input from the synthesis unit 426.

The audio output unit 432 outputs audio to the outside based on the electric signal supplied from the synthesis unit 426.

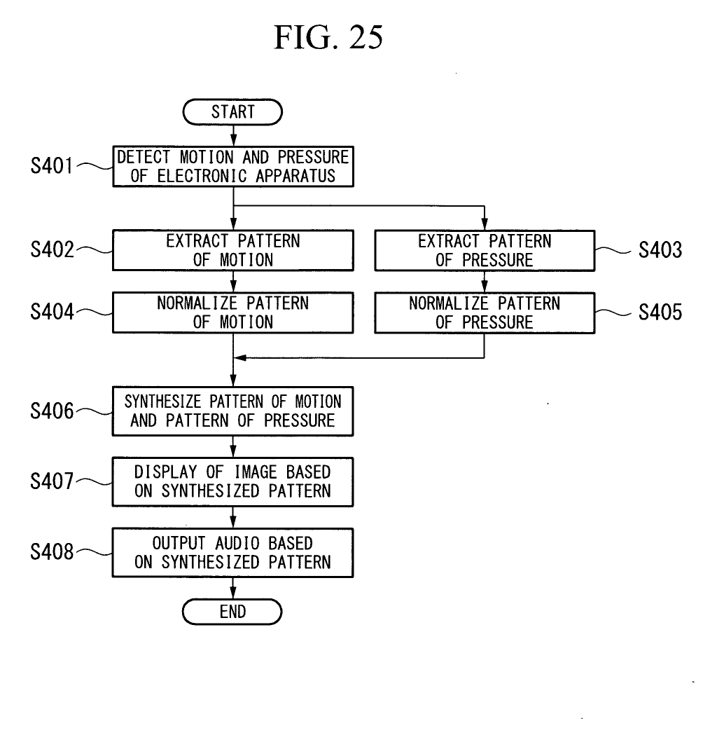

FIG. 25 is a flowchart showing a flow of the process of the electronic apparatus 401 of the fourth embodiment. First, the detection unit 410 detects the motion of the electronic apparatus and the pressure applied to the side surface of the electronic apparatus (Step S401). Next, the pattern extraction unit 423 extracts the pattern of the motion (Step S402). In parallel with this, the pattern extraction unit 423 extracts the pattern of the pressure (Step S403).

Next, the normalization unit 424 normalizes the pattern of the motion (Step S404). In parallel with this, the normalization unit 424 normalizes the pattern of the pressure (Step S405). Next, the synthesis unit 426 synthesizes the pattern of the motion and the pattern of the pressure (Step S406). Next, the display unit 431 displays the image based on the synthesized pattern (Step S407). Next, the audio output unit 432 outputs the audio based on the synthesized pattern (Step S408). In this way, the process of the flowchart ends.

As described above, when the electronic apparatus 401 is grasped and swung by the operator, the electronic apparatus detects the motion of the electronic apparatus and the pressure applied to the side surface of the electronic apparatus, and extracts the patterns of the signals, which repeatedly appear, from the signal indicating the detected motion and the signal indicating the pressure. Moreover, in the electronic apparatus 401, each extracted pattern is normalized, and each normalized pattern is synthesized based on each the amplitude.

Accordingly, the electronic apparatus 401 can increase variation in the synthesized pattern by synthesizing the plurality of patterns and can inform the synthesized pattern to the outside by the output unit 430 based on the synthesized pattern, and thus, the information detected by the electronic apparatus can be expressed in expressive way.

### Fifth Embodiment

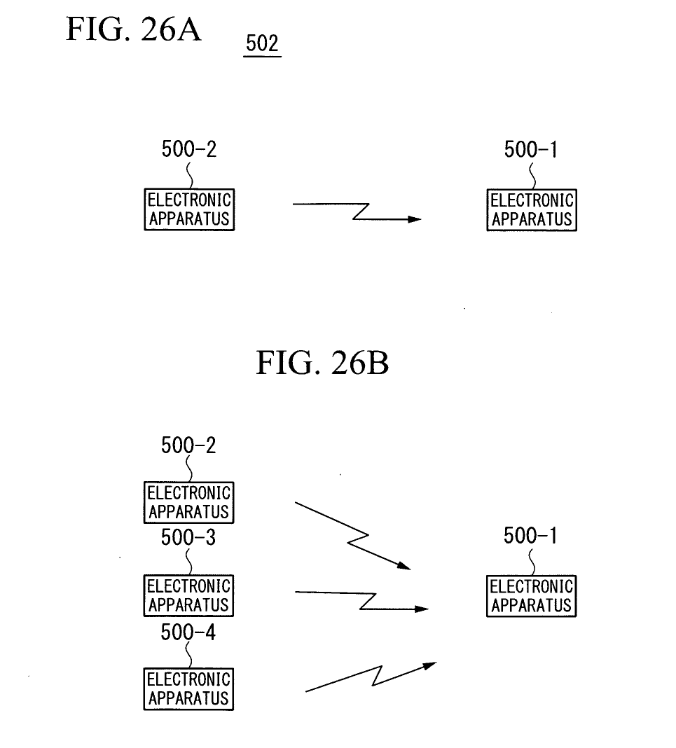

Subsequently, a communication system 502 in a fifth embodiment will be described. FIGS. 26A and 26B are configuration examples of a communication system 502 in the fifth embodiment. The communication system 502 includes a plurality of electronic apparatuses 500.

In FIG. 26A, as the configuration example of the communication system, a configuration example is shown, in which an electronic apparatus 500-2 sends the information indicating the pattern of the signal detected by the detection unit of the electronic apparatus 500-2 to an electronic apparatus 500-1.

Moreover, in FIG. 26B, as another configuration example of the communication system, a configuration example is shown, in which a plurality of electronic apparatuses 500-2, 500-3, and 500-4 send the information indicating the pattern of the signal detected by the detection unit of the respective electronic apparatus to the electronic apparatus 500-1. As shown in FIGS. 26A and 26B, the electronic apparatus 500-1 receives the information indicating the pattern of the signal detected by the detection unit of the respective electronic apparatus, from one or the plurality of electronic apparatuses.

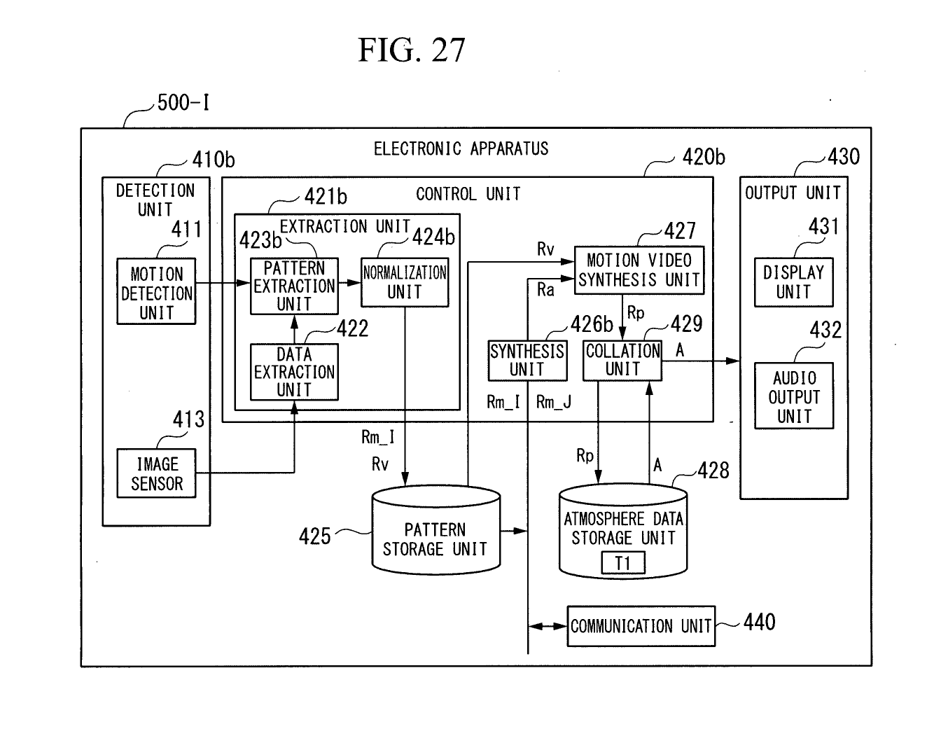

FIG. 27 is a block configuration diagram of an electronic apparatus 500-I (I is a positive integer) in the fifth embodiment. Moreover, the same reference numerals are attached to the elements common to FIG. 19, and the specific descriptions are omitted.

With respect to the configuration of the electronic apparatus 401 of FIG. 19, in the configuration of the electronic apparatus 500-I of FIG. 27, the detection unit 410 is changed to a detection unit 410b, the control unit 420 is changed to a control unit 420b, and an atmosphere data storage unit 428 and a communication unit 440 are added.

With respect to the configuration of the detection unit 410 of FIG. 19, in the detection unit 410b, the pressure detection unit 412 is removed, and an image sensor 413 is added.

The image sensor 413 captures the subject. Specifically, for example, if a case where one or a plurality of other electronic apparatuses 500 are swung in the predetermined direction by an operator or a plurality of operators is assumed, the image sensor 413 captures the one or the plurality of other electronic apparatuses 500-J (J is a positive integer other than I) as the subject.

The image sensor 413 supplies a video signal obtained by the imaging to a data extraction unit 422, which will be described below, of the extraction unit 421b. For example, as the image sensor 413, a CCD image sensor is provided.

With respect to the configuration of the control unit 420 of FIG. 19, in the control unit 420b, the extraction unit 421 is changed to extraction unit 421b, the synthesis unit 426 is changed to a synthesis unit 426b, and a motion video synthesis unit 427 and a collation unit 429 are added.

The extraction unit 421b includes the data extraction unit 422, a normalization unit 424b, and a pattern extraction unit 423b.

The data extraction unit 422 extracts the signal equivalent to the pixel on a diagonal line of a frame, from the video signal supplied from the image sensor 413. In addition, the data extraction unit 422 outputs the extracted signal (extraction video signal) to the pattern extraction unit.

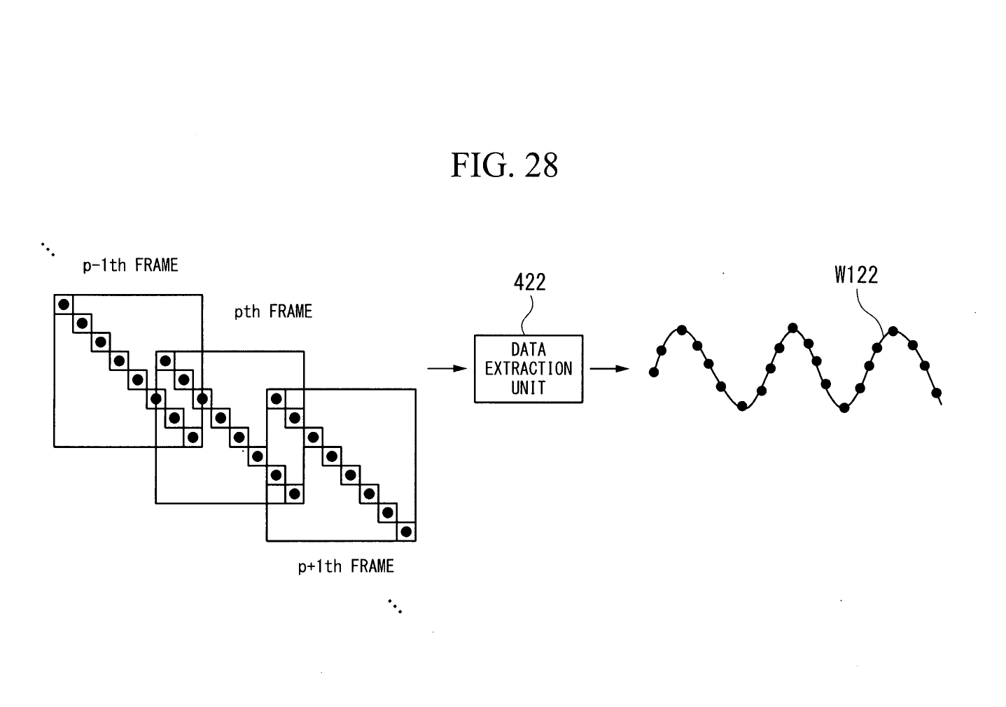

The process of the data extraction unit 422 will be described with reference to FIG. 28. FIG. 28 is a diagram for explaining the process of the data extraction unit 422. In the left side of FIG. 28, an image of a p−1th frame (p is an integer), an image of a pth frame, and an image of a p+1th frame are shown. Moreover, in each frame, images on a diagonal line which connects the upper left pixels and the lower right pixels are shown.

In the right side of FIG. 28, a curve W122 that indicates an extraction video signal configured of luminance values of the pixels on the diagonal line in the frame extracted by the data extraction unit 422. Respective points configuring the curve W122 are the luminance signals of the pixels which are arranged in order of the frames. The luminance signals of the pixels are located on the diagonal line, which connects the upper left pixels and the lower right pixels in each frame of the left side of FIG. 28.

In the example of FIG. 28, the data extraction unit 422 extracts the luminance values of the pixels, that is located on the diagonal line which connects the upper left pixels and the lower right pixels, in each frame, and outputs the data array of the extracted luminance values to the pattern extraction unit 423b as the extraction video signal.

Returning to FIG. 27, similar to the pattern extraction unit 423 of the fourth embodiment, the pattern extraction unit 423b calculates the autocorrelation function R (t) from the signal indicating the motion supplied form the motion detection unit 411, and calculates the pattern of the motion based on the calculated autocorrelation function R(t). In addition, the pattern extraction unit 423b outputs the information indicating the calculated pattern of the motion to the normalization unit 424b.

Moreover, according to a method similar to that of the pattern extraction unit 423 of the fourth embodiment, the pattern extraction unit 423b calculates the autocorrelation function R(t) from the extraction video signal supplied from the data extraction unit 422, and calculates the pattern of the video based on the calculated autocorrelation function R(t). In addition, the pattern extraction unit 423b outputs the information indicating the pattern of the calculated video to the normalization unit 424b.

Similar to the normalization unit 424 of the fourth embodiment, the normalization unit 424b normalizes the information indicating the pattern of the motion input from the pattern extraction unit 423b to the values from −1 to 1. Moreover, the normalization unit 424b stores information Rm_I indicating the pattern of the motion after normalization, in the pattern storage unit 425.

In addition, the normalization unit 424b normalizes the information indicating the pattern of the video input from the pattern extraction unit 423b to the values from −1 to 1. Moreover, the normalization unit 424b stores information Rv indicating the pattern of the video after normalization, in the pattern storage unit 425.

The control unit 420b reads the information Rm_I, which indicates the pattern of the motion after normalization, from the pattern storage unit 425 and outputs the read information Rm_I, which indicates the pattern of the motion after normalization, to the communication unit 440. Moreover, the control unit 420b is controlled to send the information Rm_I, which indicates the pattern of the motion after normalization, from the communication unit 440 to other electronic apparatuses 500-J (J is an integer other than I).

The communication unit 440 is configured to communicate with other electronic apparatuses 500-J by a wire type or a wireless type. The communication unit 440 receives the information Rm_J, which indicates the pattern of the motion after normalization of other electronic apparatuses 500-J, from other electronic apparatuses 500-J, and outputs the received information Rm_J, which indicates the pattern of the motion after normalization, to the synthesis unit 426b.

Similar to the synthesis unit 426 of the fourth embodiment, the synthesis unit 426b reads the information Rm_I, which indicates the pattern of the motion after normalization, from the pattern storage unit 425. Moreover, according to a method similar to that of the synthesis unit 426 in the fourth embodiment, the synthesis unit 426b synthesizes the read information Rm_I, which indicates the pattern of the motion after normalization, and the information Rm_J, which indicates the pattern of the motion after normalization input by the communication unit 440, according to each amplitude value.

Accordingly, the synthesis unit 426b can generate the pattern in which the pattern of the motion of the electronic apparatus itself and the patterns of the motions of other electronic apparatuses 500-J are synthesized.

In addition, the synthesis unit 426b outputs the pattern obtained by the synthesis to the motion video synthesis unit 427 as information Ra indicating the pattern of the aggregated motion.

The motion video synthesis unit 427 reads the information Rv, which indicates the pattern of the video after normalization, from the pattern storage unit 425. The motion video synthesis unit 427 synthesizes the pattern of the aggregated motion, which is synthesized by the synthesis unit 426b, and the pattern of the extracted video. Specifically, the motion video synthesis unit 427 synthesizes the information Ra, which indicates the pattern of the aggregated motion input from the synthesis unit 426b, and the read information Rv, which indicates the pattern of the video after normalization, according to the amplitude.

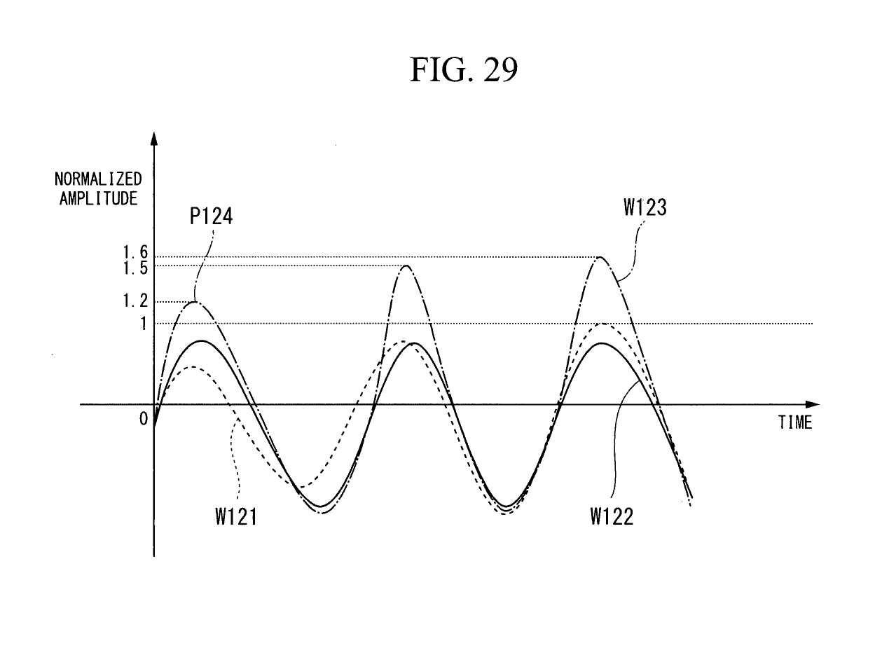

The process of the motion video synthesis unit 427 will be described with reference to FIG. 29. FIG. 29 is a diagram for explaining the process of the motion video synthesis unit 427. In FIG. 29, the vertical axis indicates the normalized amplitude and the horizontal axis indicates time. In FIG. 29, a curve W121 indicating the pattern of the aggregated motion, a curve W122 indicating the pattern of the video after normalization, and a curve W123 indicating the synthesis pattern synthesized by the motion video synthesis unit 427 are shown.

For example, the motion video synthesis unit 427 adds a value 0.6, which is a value on the curve W121 indicating the pattern of the aggregated motion, and a value 0.8, which is a value on the curve W122 indicating the pattern of the video after normalization, and multiples a coefficient 0.8, which corresponds to the combination (0.6 and 0.8) of the amplitude of each pattern, to the value 1.4 obtained by the addition of the value 0.6 and value 0.8. The obtained value 1.12 is set to the amplitude of a peak P124 on the curve W123 indicating the synthesis pattern.

Returning to FIG. 19, the motion video synthesis unit 427 outputs the synthesis pattern obtained by the synthesis to the collation unit 429 as information Rp indicating the pattern of a location.

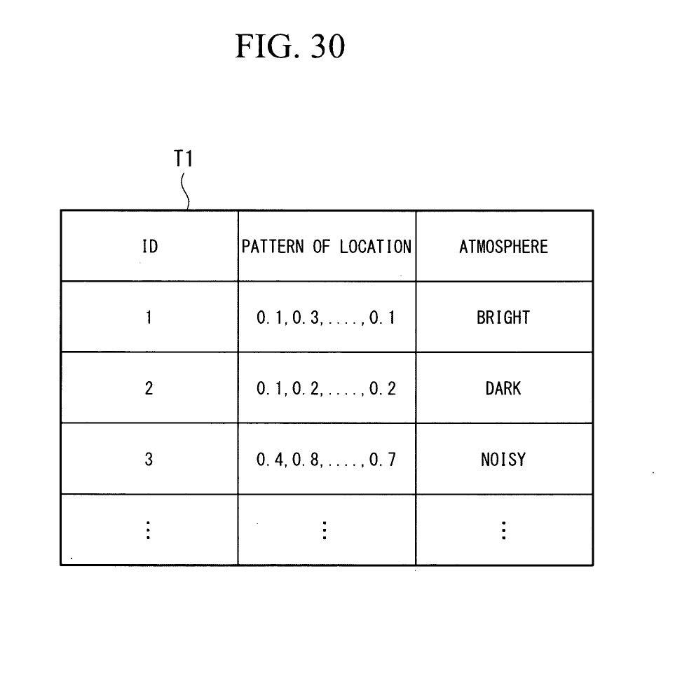

The information Rp indicating the pattern of the location and information A indicating atmosphere are associated with each other and are stored in the atmosphere data storage unit 428. FIG. 30 is a diagram showing an example of Table T1 which is stored in the atmosphere data storage unit 428.

In Table T1, inherent identification information (ID) in the pattern of the location, the pattern of the location, and atmosphere are associated with one another. For example, when ID is 1, bright atmosphere is associated with the patterns of the location (0.1, 0.3, . . . , 0.1)

Returning to FIG. 27, the collation unit 429 reads the information A, indicating the atmosphere corresponding to the information Rp which indicates the pattern of the location input from the motion video synthesis unit 427, from the atmosphere data storage unit 428. Moreover, the collation unit 429 outputs the information A indicating the read atmosphere to the display unit 431. In addition, the collation unit 429 outputs the electric signal based on the information A indicating the atmosphere to the audio output unit 432.

Moreover, when the information A, indicating the atmosphere corresponding to the information Rp which indicates the pattern of the location, does not exist in the record of the atmosphere data storage unit 428, the collation unit 429 may extract the pattern of the location nearest to the information Rp indicating the pattern of the location, and may read the information A, indicating the atmosphere corresponding to the extracted pattern of the location, from the atmosphere data storage unit 428.

The display unit 431 displays the information indicating the atmosphere based on the information A indicating the atmosphere input from the collation unit 429. Moreover, the audio output unit 432 outputs audio based on the electric signal input from the collation unit 429.

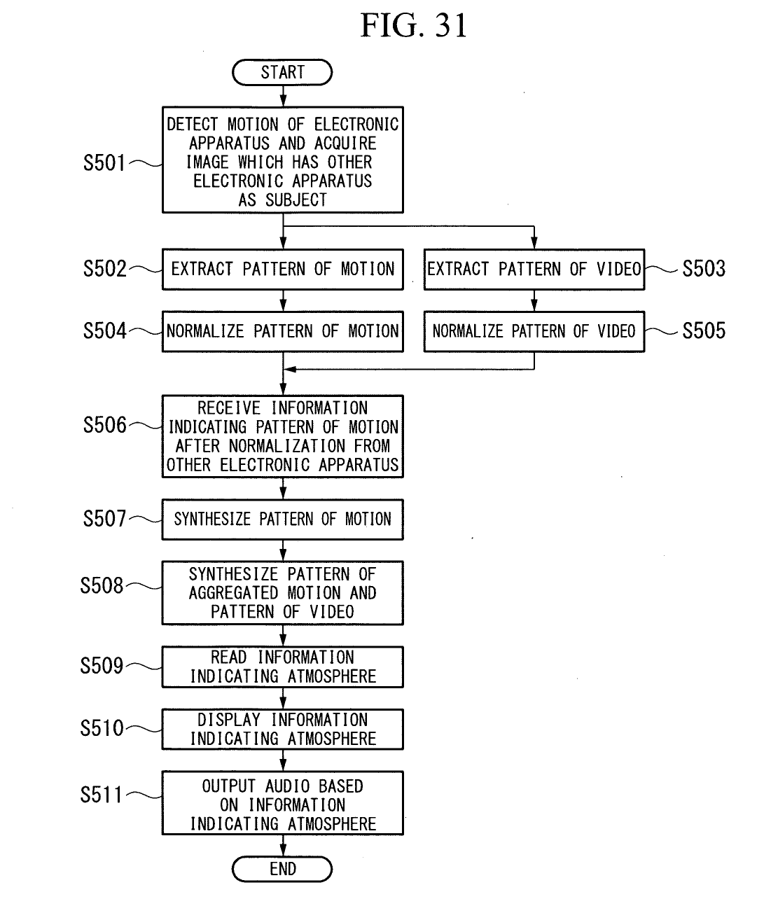

FIG. 31 is a flowchart showing the flow of the process of the electronic apparatus 500-I of the fifth embodiment. First, the detection unit 410b detects the motion of the electronic apparatus 500-I, and in parallel with this, acquires the video with other electronic apparatuses 500-J as the subject (Step S501).

Next, the pattern extraction unit 423b extracts the pattern of the motion from the motion of the electronic apparatus 500-I (Step S502). In parallel with this, the pattern extraction unit 423b extracts the pattern of the acquired video (pattern S503).

Next, the normalization unit 424b normalizes the pattern of the extracted motion (Step S504). In parallel with this, the normalization unit 424b normalizes the pattern of the extracted video (Step S505).

Next, the communication unit 440 receives the information indicating the patterns of the motions of other electronic apparatuses after normalization from other electronic apparatuses (Step S506). Next, the synthesis unit 426b generates the pattern of the aggregated motion which is obtained by synthesizing the pattern of the motion of the electronic apparatus 500-I after normalization and the patterns of the motions of other electronic apparatuses after normalization (Step S507).

Next, the motion video synthesis unit 427 synthesizes the pattern of the aggregated motion and the pattern of the video (Step S508). The collation unit 429 reads the information indicating the atmosphere corresponding to the pattern of the location which is synthesized by the motion video synthesis unit 427 (Step S509). Next, the display unit 431 displays the read information indicating the atmosphere (Step S510). Next, the audio output unit 432 outputs audio based on the information indicating the atmosphere (Step S511). In this way, the process of the flowchart ends.

As described above, the electronic apparatus 500-I in the second embodiment extracts the pattern of the motion from the motion of each electronic apparatus 500-I. Moreover, the electronic apparatus 500-I generates the pattern of the aggregated motion by synthesizing the motion pattern of the electronic apparatus 500-I and the motion patterns of other electronic apparatuses 500-J. The electronic apparatus 500-I generates the pattern of the location, in which the subject exists, by further synthesizing the generated pattern of the aggregated motion and the video pattern, which is based on the luminance change which is obtained from the video capturing other electronic apparatuses 500-J which are the subjects. Moreover, the electronic apparatus 500-I reads the information indicating the atmosphere corresponding to the pattern of the location, from the atmosphere data storage unit 428.

Accordingly, the electronic apparatus 500-I can generate the pattern of the location, from the video signal capturing the location and the information indicating the motion of the electronic apparatus 500-I and other electronic apparatuses 500-J. As a result, the electronic apparatus 500-I can estimate the atmosphere of the location from the generated pattern of the location.

In addition, in the present embodiment, the electronic apparatus 500-I synthesizes the pattern of the motion of the electronic apparatus 500-I and the patterns of the motions of other electronic apparatuses. However, the synthesis is not limited to this. For example, the electronic apparatus 500-I may synthesize the pattern of the pressure applied to the side surface of the electronic apparatus 500-I and the pattern of the pressure applied to the side surfaces of other electronic apparatuses 500-J.

In the present embodiment, when all amplitude of each pattern is larger than a predetermined threshold value, the motion video synthesis unit 427 determines the amplitude of the pattern obtained by the synthesis based on the amplitude of each pattern. However, the determination is not limited to this. The motion video synthesis unit 427 may set the average value of each pattern to the amplitude of the pattern obtained by the synthesis.

Moreover, in the fourth embodiment and the fifth embodiment, when all amplitude of each pattern is larger than a predetermined threshold value, the synthesis units (426 and 426b) determine the amplitude of the pattern obtained by the synthesis based on the amplitude of each pattern. However, the determination is not limited to this. The synthesis units (426 and 426b) may set the average value of each pattern to the amplitude of the pattern obtained by the synthesis.

In all embodiments, the output unit 430 informs to the outside using image and audio, but, is not limited to this, and the output unit may inform to the outside using light or vibration.

Moreover, by recording a program for executing each process of the electronic devices (1, 201, and 301) and the control units (420 and 420b) according to an embodiment of the present invention on a computer-readable recording medium and by executing the program recorded on the recording medium to be read on a computer system, the above-described various process related to the electronic devices (1, 201, and 301) and the control units (420 and 420b) may be performed. In this case, the information indicating the plurality of signals detected by the plurality of detection units is set to be stored in the recording medium. Moreover, the above-mentioned “computer system” may include an OS or hardware such as peripheral equipment. Moreover, when a WWW system is used, the “computer system” is set to include a homepage provision environment (or display environment). In addition, the “computer-readable recording medium” means a writable non-volatile memory such as a flexible disk, a magneto-optical disk, a ROM, a flash memory, a portable medium such as a CD-ROM, and a storage apparatus such as a hard disk which is built in the computer system.

Furthermore, the “computer-readable recording medium” may include a volatile memory (for example, a Dynamic Random Access Memory (DRAM)) inside a computer system which becomes a server or a client when a program is sent via a network such as the Internet or a communication channel such as a telephone channel, in which the volatile memory holds the program during a definite period of time. In addition, the program may be transmitted to other computer systems via a transmission medium or by transmission waves in the transmission medium from the computer system which stores the program in the storage apparatus or the like. Here, the “transmission medium” which transmits the program means a medium, which has a function which transmits information, such as a network (communication network) of Internet or the like or a communication channel (communication line) of a telephone channel. Moreover, the program may execute a portion of the above-described functions. Moreover, the program may be a so-called differential file (differential program), in which the above-described functions can be realized by combining the program and a program which has been recorded on the computer system in advance.

As described above, the embodiments of the present invention are described with reference to the drawings. However, the specific configurations are not limited to the embodiments and include a design or the like within a scope which does not depart from the gist of the present invention.

What is claimed is:

1. An electronic device comprising:
a storage unit that is configured to store rhythm information which indicates a pattern of a spatial change in an image associated with a pattern of a spatial change in a unit region in an image;
an imaging unit;
a calculation unit that is configured to calculate a pattern of a change in a unit region in an image captured by the imaging unit; and
a selection unit that is configured to select the rhythm information from the storage unit, the rhythm information being corresponding to the pattern of the change in the unit region calculated by the calculation unit.

2. The electronic device according to claim 1,
wherein the storage unit stores the rhythm information associated with a combination of a first pattern and a second pattern, the first pattern being a pattern of a change in a unit region and the second pattern being a pattern of a change in a unit region,
wherein the calculation unit calculates a pattern of a change in a unit region which configures a main object in the captured image, and a pattern of a change in a unit region which configures a portion other than the main object, and
wherein the selection unit selects the rhythm information, in which the first pattern corresponds to a pattern of a change in a unit region which configures the main object calculated by the calculation unit and the second pattern corresponds to a pattern of a change in a unit region which configures the portion other than the main object calculated by the calculation unit, from the storage unit.

3. The electronic device according to claim 1,
wherein the unit region is a pixel group configured of adjacent pixels having a predetermined number, and
wherein a pattern of a change in a unit region is information that indicates a spatial change in an average pixel value, a maximum pixel value, a minimum pixel value, or a medium value of a pixel value for the each pixel group.

4. The electronic device according to claim 1,
wherein the unit region is a pixel group configured of adjacent pixels having a predetermined number, and
wherein a pattern of a change in a unit region is information in which changes in a frequency region and a time region are extracted as rhythm from information of each pixels within the pixel group.

5. The electronic device according to claim 1,
wherein the unit region is a pixel group configured of adjacent pixels in which a difference of pixel values is a predetermined value or less, and
wherein a pattern of a change in a unit region is information that indicates a spatial change of an average pixel value, a maximum pixel value, a minimum pixel value, or a medium value of a pixel value for each pixel group.

6. The electronic device according to claim 1,
wherein a pattern of a change in a unit region is information that indicates a distribution of a pixel group configured of adjacent pixels in which a difference of pixel values is a predetermined value or less.

7. A selection method that selects rhythm information of an image captured by an imaging unit, in an electronic device comprising a storage unit that is configured to store the rhythm information that indicates a pattern of a spatial change in an image associated with a pattern of a spatial change in a unit region in the image, the method comprising:
calculating a pattern of a change in a unit region in the captured image by using a calculation unit of the electronic device, and
selecting the rhythm information from the storage unit by using a selection unit of the electronic device, the rhythm information being corresponding to the pattern of the change in the unit region calculated by the calculation unit.

8. An electronic device comprising:
an imaging unit;
an extraction unit that is configured to extract an object graphic which is a graphic indicating a region of object from a moving picture captured by the imaging unit; and
an acquisition unit which acquires a variation of an area of the object graphic of an object or a period of a change in the area of the object graphic of the object as rhythm information indicating a temporal change of the object, the first object being extracted by the extraction unit.

9. The electronic device according to claim 8,
wherein the extraction unit extracts a circumscribing rectangle, which circumscribes an object, as the object graphic.

10. The electronic device according to claim 9,
wherein the acquisition unit acquires a variation of an aspect ratio of the circumscribing rectangle or a period of a change in the aspect ratio of the circumscribing rectangle as the rhythm information, instead of or in addition to a variation of an area of the circumscribing rectangle or a period of a change in the area of the circumscribing rectangle, the circumscribing rectangle being extracted as the object graphic.

11. An electronic device comprising:
an imaging unit;
an extraction unit that is configured to extract a circumscribing rectangle, which circumscribes an object, as an object graphic from a moving picture captured by the imaging unit, the object graphic being a graphic indicating a region of an object; and
an acquisition unit that is configured to acquire a variation of a length of a long side or a short side of the circumscribing rectangle or a period of a change in the length of the circumscribing rectangle as rhythm information indicating a temporal change in the object, the circumscribing rectangle being extracted as the object graphic of an object by the extraction unit.

12. The electronic device according to claim 11,
wherein the acquisition unit acquires a variation of an aspect ratio of the circumscribing rectangle or a period of a change in the aspect ratio of the circumscribing rectangle as the rhythm information, instead of or in addition to a variation of the length of the long side or the short side, or a period of a change of the length of the circumscribing rectangle.

13. An acquisition method of rhythm information in an electronic device which acquires the rhythm information from a moving picture, the rhythm information being indicating a temporal change in an object in a moving picture, the method comprising:
extracting an object graphic from the moving picture by using an extraction unit of the electronic device, the object graphic being a graphic indicating a region of an object, and
acquiring a variation of an area of the object graphic of a first object or a period of the change in the area of the object graphic of the first object as rhythm information by using an acquisition unit of the electronic device, the first object being extracted by the extraction unit and the rhythm information being indicating a temporal change in the object.

14. An electronic device comprising:
an imaging unit; and
an extraction unit that is configured to extract rhythm information indicating a pattern of a color change of an object in a moving picture which is captured by the imaging unit.

15. The electronic device according to claim 14, further comprising:
a correction unit that is configured to correct a color of the moving picture to a color obtained in a case the moving picture was captured under a predetermined reference light,
wherein the extraction unit extracts the rhythm information from a moving picture which is corrected by the correction unit.

16. The electronic device according to claim 14,
wherein the extraction unit comprises:
a storage unit that is configured to store the rhythm information associated with a pattern of a color change of a unit region configuring the object;
a calculation unit that is configured to calculate the pattern of the color change of the unit region in the moving picture; and
a selection unit that is configured to select the rhythm information from the storage unit, the rhythm information being corresponding to the pattern of the color change of the unit region calculated by the calculation unit.

17. The electronic device according to claim 16,
wherein the unit region is a pixel group configured of adjacent pixels having a predetermined number, and
wherein the pattern of the color change of the unit region is information that indicates a temporal change of an average pixel value, a maximum pixel value, a minimum pixel value, or a medium value of a pixel value for each pixel group.

18. The electronic device according to claim 16,
wherein the unit region is a pixel group configured of adjacent pixels in which a difference of pixel values is a predetermined value or less, and
wherein the pattern of the color change of the unit region is information that indicates a temporal change of an average pixel value, a maximum pixel value, a minimum pixel value, or a medium value of a pixel value for each pixel group.

19. The electronic device according to claim 16,
wherein the unit region is a pixel group configured of adjacent pixels in which a difference of pixel values is a predetermined value or less, and
wherein the pattern of the color change of the unit region is information indicating a temporal change of a distribution of the pixel group.

20. The electronic device according to claim 14,
wherein the color change comprises changes of any one or two or more of hue, chroma, brightness, chromaticity, and a contrast ratio.

21. A selection method that selects rhythm information of a moving picture captured by an imaging unit, in an electronic device comprising a storage unit that is configured to store the rhythm information that indicates a pattern of a color change in an object in the moving picture associated with a pattern of a color change of a unit region configuring the object in the moving picture, the method comprising:
calculating the pattern of the color change of the unit region in the moving picture by using a calculation unit of the electronic device, and
selecting the rhythm information from the storage unit, the rhythm information being corresponding to the pattern of the color change of the unit region calculated by the calculation unit by using a selection unit of the electronic device.

22. An electronic apparatus, comprising:
a plurality of detection units that is configured to detect a plurality of signals from a detection target, the plurality of signals being indicating characteristics of a target;
an extraction unit that is configured to extract each of patterns of the signals, which repeatedly appear, from the plurality of signals detected by the plurality of detection units; and
a synthesis unit that is configured to synthesize each extracted pattern.

23. An electronic apparatus, comprising:
a detection unit that is configured to detect a signal, which indicates characteristics of a target, from a detection target;
an extraction unit that is configured to extract a pattern of a signal, which repeatedly appears, from the signal detected by the detection unit;
a communication unit that is configured to receive information indicating a pattern of a signal detected by an other electronic apparatus; and
a synthesis unit that is configured to synthesize the pattern received by the communication unit and the pattern extracted by the extraction unit.

24. The electronic apparatus according to claim 22,
wherein, when all amplitudes of the each patterns are larger than a predetermined threshold, the synthesis unit determines an amplitude of a pattern obtained by a synthesis based on the amplitude of the each patterns.

25. The electronic apparatus according to claim 22,
wherein the synthesis unit sets an average value of the each patterns to an amplitude of a pattern obtained by a synthesis.

26. The electronic apparatus according to claim 22, further comprising:
an output unit that is configured to inform toward an outside of the electronic apparatus based on the pattern synthesized by the synthesis unit.

27. The electronic apparatus according to claim 23,
wherein the detection unit detects a motion of the electronic apparatus,
wherein extraction unit extracts a pattern of a motion of the electronic apparatus from the detected motion,
wherein the communication unit receives information indicating a pattern of a motion of an other electronic apparatus detected by the other electronic apparatus, and
wherein the synthesis unit synthesizes the pattern of the motion of the electronic apparatus and the pattern of the motion of the other electronic apparatus.

28. The electronic apparatus according to claim 27,
wherein the detection unit photographs a subject,
wherein the extraction unit extracts a pattern of a video from the video obtained through photographing by the detection unit, and
wherein the electronic apparatus comprises a motion video synthesis unit that is configured to synthesize the pattern of the motion, which is synthesized by the synthesis unit, and the pattern of the extracted video.

29. A synthesis method, comprising:
a plurality of detection steps that detect a plurality of signals indicating characteristics of a target from a detection target;
an extraction step that extracts each of the patterns of the signals, which repeatedly appear, from plurality of signals detected at the plurality of detection steps; and
a synthesis steps that synthesizes each extracted pattern.

30. A synthesis program causing a computer, which comprises a storage unit in which information indicating a plurality of signals detected by a plurality of detection units is stored, to execute:
an extraction step that reads information, which indicates a plurality of signals, from the storage unit, and extracts the each of the patterns of the signals, which repeatedly appear, from the information indicating the plurality of read signals; and
a synthesis step of synthesizing each extracted pattern.
